(19) United States
(12) Patent Application Publication
(10) Pub. No.: US 2024/0276279 A1
(43) Pub. Date: Aug. 15, 2024

(54) DEVICE AND METHOD FOR TRANSMITTING AND/OR RECEIVING AN ENRICHED LINK LEVEL REPORT

(71) Applicant: Fraunhofer-Gesellschaft zur Förderung der angewandten Forschung e.V., München (DE)

(72) Inventors: Thomas HAUSTEIN, Berlin (DE); Paul Simon Holt LEATHER, Berlin-Schlachtensee (DE)

(21) Appl. No.: 18/643,848

(22) Filed: Apr. 23, 2024

Related U.S. Application Data
(63) Continuation of application No. PCT/EP2022/078579, filed on Oct. 13, 2022.

(30) Foreign Application Priority Data
Oct. 29, 2021 (EP) 21205718.6

(51) Int. Cl. H04W 24/10

(52) U.S. Cl. CPC H04W 24/10

(57) ABSTRACT

A method and a device for use in a wireless communication system are described, the device having a communication link to at least a second device, wherein the device is configured to transmit and/or receive a link-level report, and/or wherein the device is configured to control the communication link by means of the link-level report or configured to be controlled based on information contained in the link-level report, the link-level report having at least one of an information about a) a root cause of a change in link-level performance of the communication link, b) a measure to change link-level performance of the communication link, and c) a trend and/or an anticipated behavior of link-level performance of the communication link.

### CROSS-REFERENCE TO RELATED APPLICATIONS

This application is a continuation of copending International Application No. PCT/EP2022/078579, filed Oct. 13, 2022, which is incorporated herein by reference in its entirety, and additionally claims priority from European Application No. 21205718.6, filed Oct. 29, 2021, which is also incorporated herein by reference in its entirety.

### TECHNICAL FIELD

The present invention concerns network performance enhancements using enriched link-level reports. Embodiments of the present disclosure relate to a device for use in a wireless communication system and a method for operating such a device. The device comprises a communication link to at least one further device. The inventive device is configured to transmit and/or receive a link-level report to/from said further device. The link level report comprises information about a status of the communication link, wherein said information can be enriched with more detailed background information as to a variation or change in the performance of the communication link.

### BACKGROUND OF THE INVENTION

Wireless Communication Systems (WCS) use antennas to transmit signals between a transmitter and a receiver by suitably mapping control and user plane data to a wireless carrier, thus forming a link between two or more wireless nodes. In order to allow message transfer according to some criterion, for example above a minimum throughput or below a maximum latency, state-of-the-art wireless links are preferred to operate in closed loop.

Such links use knowledge of the transmission capabilities and the quality of the wireless channel so that the loading of the channel is close to the Shannon channel capacity. The effects of noise and the availability of bandwidth are considered to be the main limitations to capacity. Interference is typically treated as a form of (coloured) noise. Therefore, many of the algorithms used from high-level scheduling through to low-level channel coding are mainly optimized for noise limited cases rather than for the effects of interference per se.

In a radio communication system, the received signal usually consists of an information-bearing signal component, a random interference component, and receiver noise. Interference and noise can be of either deterministic or stochastic nature.

A variable is said to be stochastic if the occurrence of events or outcomes involves randomness or uncertainty while a process is described as being stochastic if it governs one or more stochastic variables. The term stochastic is thus used to commonly describe mathematical processes that use or harness randomness. Common examples include Brownian motion, Markov processes, Monte Carlo sampling and radio communications.

Contrary to a stochastic process, a deterministic process is one in which the output state or response to a known and given input state or set of stimuli is determined by the value of those states or stimuli and, therefore, no randomness is involved in the development of future states. A deterministic model will thus always produce the same output from a given starting condition or initial state.

The approach of treating interference in a manner similar to the treatment of noise is straightforward providing that the interference is shaped such that its effect becomes stochastic in nature such as would be the effect of fading. In practice, intercell interference may be approximated as a stochastic process when users are scheduled in a randomized manner using time and frequency resources.

As an example, current channel-aware coding uses a quantized modulation and coding scheme (MCS) in combination with a request for retransmissions of missed packets, wherein a packet error rate of 5% to 10% is considered a suitable point of operation. Depending on the root cause of packet errors, for example noise or fast fading, this approach may be suitable. However, for other reasons, such as sudden blockage or severe deterministic interference, the approach may lead to: a) undesired link degradation and continued packet loss even after k-repetitions (H-ARQ); or b) an under-utilization of the wireless link.

Using an acknowledgement scheme, state-of-the-art receivers provide an acknowledged (ACK) or not-acknowledged (NACK) to the transmitter. When the transmitting end of the link receives a NACK, it will initiate a retransmission of the missed packet. However, the form of NACK used in state-of-the-art devices does not provide any other information than that the packet was missed.

Another form of feedback to enable suitable link adaptation is to provide a channel quality indicator (CQI) from the receiver to the transmitter. The CQI can contain a SINR value or its equivalent which may be an indication of the quality determined within a certain bandwidth, a bandwidth part (BWP), one or more specific resource blocks (RBs), a beam or a slot. The reported CQI value therefore represents the result of an averaging process. For example, a CQI value associated with a given BWP does not disclose variations over time and/or frequency. In this case, two CQI values may look similar even though the underlying statistics (e.g. the variance) could be different. Furthermore, while some RBs within the BWP may be below the average CQI in either a deterministic or a stochastic manner, this nature is not revealed in the CQI itself, due to its averaging nature.

In known technology, neither H-ARQ nor CQI provide more detailed statistical indication information than a Boolean indication or an averaged value, respectively. Therefore, the transmitting end of the link cannot adapt its strategy according to the underlying mechanism causing link or channel degradation (i.e., a stochastic effect such as noise or deterministic effects such as specific interference). Similarly, the receiver is also unable to adapt optimally.

Thus, it is desired to provide devices for wireless communication systems, which devices overcome the above limitations of the known technology. In particular, it would be desirable to provide devices which are capable of providing a more detailed insight into a root cause being responsible for a varying performance of a communication channel.

### SUMMARY

An embodiment may have a device for use in a wireless communication system, the device having a communication link to at least a second device, wherein the device is configured to transmit and/or receive a link-level report, and/or wherein the device is configured to control the communication link by means of the link-level report or configured to be controlled based on information contained in the link-level report, the link-level report having at least one of an information about
a root cause of a change in link-level performance of the communication link,
a measure to change link-level performance of the communication link, and
a trend and/or an anticipated behavior of link-level performance of the communication link.

According to another embodiment, a method for operating a device in a wireless communication system may have the steps of: providing a communication link to at least a second device, transmitting and/or receiving a link-level report, and/or controlling the communication link by means of the link-level report or being controlled based on information contained in the link-level report, the link-level report having at least one of an information about
a root cause of a change in link-level performance of the communication link,
a measure to change link-level performance of the communication link, and
a trend and/or an anticipated behavior of link-level performance of the communication link.

Another embodiment may have a non-transitory digital storage medium having stored thereon a computer program for performing a method for operating a device in a wireless communication system, the method having steps of: providing a communication link to at least a second device, transmitting and/or receiving a link-level report, and/or controlling the communication link by means of the link-level report or being controlled based on information contained in the link-level report, the link-level report having at least one of an information about
a root cause of a change in link-level performance of the communication link,
a measure to change link-level performance of the communication link, and
a trend and/or an anticipated behavior of link-level performance of the communication link,

when said computer program is run by a computer.

According to a first aspect, a device for use in a wireless communication system is provided, said device comprising a communication link to at least one second device. The device is configured to transmit and/or receive a link-level report, which contains information about the communication link. Additionally or alternatively, the device is configured to control the communication link by means of the link-level report. For example, the device may be configured to control the communication link by exploiting any information contained in the link-level report. Yet further additionally or alternatively, the device is configured to be controlled via the communication link, in particular based on information contained in the link-level report. Depending on the current (environmental) situation the communication link may comprise a certain performance, which may also be referred to as a link-level performance. During a communication between the device and the second device, the link-level performance may vary or change over time, for example due to a (spontaneous) presence of a source of interference. For example, a vehicle (e.g. a car, a train, etc.) may drive through or between two communicating devices. Thus, the communication path between the two communicating devices may be interfered by the vehicle (source of interference) which may lead to a variation or change in the link-level performance compared to a situation without said interferer. In this case, the link-level performance may usually be degraded. Another example could be the presence of a repeater sitting in a communication path between two communicating devices. Said repeater may enhance signals being transferred between the two devices, i.e. the link-level performance of the communication link between said two devices may vary or change. In this case, the link-level performance may usually be enhanced. According to the invention, the link-level report may comprise an information about a root cause of a variation or change in link-level performance of the communication link, for example a root cause that caused a degradation and/or an enhancement of the communication link. Since a root cause has usually happened (or at least began to happen) in the past, this information about the root cause can be seen as an information regarding the past. Thus, the information about the root cause, which may be contained in the link-level report, can give an insight into what happened such that the performance of the communication link has changed. Additionally or alternatively, the link-level report may comprise an information about a measure to change the link-level performance of the communication link. For example, if the link-level performance may have changed due to a certain root cause, then the link-level report may contain an information about a counter measure that can be applied by at least one of the two devices in order to alleviate or compensate the change of the link-level performance. For instance, if the link-level performance may have degraded due to a certain root cause (e.g. interference), the link-level report may contain an information about a counter measure that can be applied in order to enhance the degraded link-level again. Such a counter measure could be an applied hardware measure, e.g. turning the device or an antenna of the device into a certain direction, and/or an applied software measure, e.g. directing an antenna beam to a certain spot. Said information about a (counter) measure may be regarded as an information about the present, e.g. to provide a counter measure right now in order to change the performance of the communication link. Yet further additionally or alternatively, the link-level report may comprise an information about a trend and/or an anticipated behavior of the link-level performance of the communication link. For example, the device may predict a future behavior of the performance of the communication link. For instance, the device may detect a certain source of interference and the device may be aware that this source of interference will somehow affect the performance of the communication link. In other words, the device may take a look into the future in order to see how the performance of the communication link will potentially behave in certain situations or time instances.

A second aspect concerns a corresponding method for operating an inventive device in a wireless communication system, the method comprising a step of providing a communication link to at least one second device. The method may further comprise a step of transmitting and/or receiving a link-level report. Additionally or alternatively, the method may comprise a step of controlling the communication link by means of the link-level report and/or a step of being controlled via the communication link, in particular by means of information contained in the link-level report. According to the inventive principle, the link-level report comprises at least one of an information about a root cause of a change in link-level performance of the communication link, a measure to change link-level performance of the communication link, and a trend and/or an anticipated behavior of link-level performance of the communication link.

According to a third aspect, computer programs are provided, wherein each of the computer programs is configured to implement the above-described method when being executed on a computer or signal processor, so that the above-described method is implemented by one of the computer programs.

The invention may provide a link-level report that contains additional information compared to the known technology. Thus, the inventive link-level report may be referred to as an enhanced or enriched link level report (eLLR) that can be used for, e.g. the link itself, other links, and network optimization in general. Furthermore, the combination of eLLRs from multiple links offers additional benefits to individual links and to the network. Therefore, the invention may provide an additional benefit of eLLR becoming a part of minimization of drive testing (MDT).

It is to be noted that the device according to the invention may be a receiver of a link-level report or a transmitter of a link-level report. Accordingly, the device may be configured to receive a link-level report and to retrieve information contained therein. Otherwise, when acting as a transmitter of a link-level report, the device may be configured to create information and include said information into the link-level report.

Furthermore, the process of communication is fundamentally one of a probabilistic nature. To appreciate this intrinsic property of the communication process, it is recognized that if the receiver of a communication system were to know the composition of a message exactly, then it would be pointless to have the system transmit that message.

Naturally occurring noise is a major source of uncertainty in a communication system and is present in the front-end electronics of the receiver. The two most common types of such noise are thermal noise, e.g. produced by the random motion of electrons in a conducting material, and shot noise, e.g. created by the random flow of current in electronic devices. Undesirable external sources or effects, which are collectively known as interference, may further affect the signal received. The net effect is that the received signal is random-like in appearance. Thus, it may be of interest whether noise or interference occurring in a probabilistic communication process may be of either stochastic or deterministic nature.

According to some embodiments, the link-level report may contain an information (e.g. as part of the information about a root cause) whether a root cause may be of stochastic nature or of deterministic nature. In contrast to the above discussed known technology, the invention provides a benefit in that local knowledge can be obtained about the nature of bit loss and/or packet loss, wherein the nature may be categorized as stochastic (within the scope the current mode of operation is chosen for) or deterministic, wherein different measures can be chosen to avoid link degradation or to improve the channel quality by appropriate means, for example, the coordination of resources (RBs) among gNBs and users suffering from such interference.

The invention may provide further benefits by retrieving low level PHY information (for example, soft bits and their mapping on time and frequency resources) at a receiver to determine if a bit error or packet error behaviour follows deterministic and/or stochastic behaviour. Furthermore, feedback provided about the nature of the behaviour may enable the transmitter to adapt its transmission strategy appropriately. In brief, as long as packet errors follow a (specific) stochastic behaviour, the wireless link can be operated with means optimized for such (packet error) behaviour. However, in the case of feedback describing the deterministic nature of packet errors, the transmit strategy or a combined transmit/receive strategy can be suitably adapted to tackle the effects of the root cause.

The invention may provide further benefits by providing additional information that describes particular stochastic and deterministic behaviour or effects. In other words, further to providing an indication of whether the effect is simply classified as being stochastic or deterministic, additional insights can be provided that describe the type of effect, for example, a stochastic channel could have a Gaussian-like distribution which could be further described by its mean and variance. Similarly, a deterministic effect can be described in combination with other parameters, for example, dependencies on time, frequency, space, location, orientation, power-level, bandwidth, polarization and so on.

Since there exist a variety of deterministic effects which can degrade the wireless channel quality and reliability, the portfolio of appropriate counter-measures, including beamforming, beam-coordination, beam correspondence, scheduling, gNB selection, hand-over, band selection etcetera, seems almost endless. This invention therefore addresses the basic mechanism behind these effects.

### BRIEF DESCRIPTION OF THE DRAWINGS

Some application examples and exemplary embodiments will now be described in more detail with reference to the appended figures, in which:

FIG. 1 shows a schematic of a bi-directional communication link between two communication system entities—in this case a gNB and a UE—and a unidirectional link used for an inventive enhanced link level reporting (eLLR);

FIG. 2 shows a schematic of an inventive enhanced link-level reporting in a multipath propagation scenario;

FIG. 3A shows a schematic of a bi-directional communication link between two communication system entities—in this case a first gNB and a first UE—and a unidirectional link used for an inventive enhanced link level reporting (eLLR-1);

FIG. 3B shows the schematic of FIG. 3A in additional presence of interference from a source of interference (SOI);

FIG. 4 shows a schematic of bi-directional communication links between inventive communication system entities—in this case a first gNB, a first UE and a second UE—and two unidirectional links used for an inventive enhanced link level reporting (eLLR-1 and eLLR-2);

FIG. 5 shows the schematic of FIG. 4, wherein the eLLR from a first link is provided to a second link and, similarly, the eLLR from a second link is provided to a first link;

FIG. 6 shows a schematic of bi-directional communication links between various wireless communication system entities—in this case a first and a second cell, each comprised of one gNB (gNB1 and gNB2) and two UEs (UE1 with UE2 and UE3 with UE4)—and unidirectional links used for an inventive enhanced link level reporting to gNB1 (eLLR-1 and eLLR-2) and to gNB2 (eLLR-3 and eLLR-4) in a scenario of inter-cell interference (ICI);

FIG. 7 shows a schematic of bi-directional communication links between various wireless communication system entities—in this case a first and a second cell, each comprised of one gNB (gNB1 and gNB2) and two UEs (UE1 with UE2 and UE3 with UE4)—wherein unidirectional links used for an inventive enhanced link level reporting to gNB1 (eLLR-1 and eLLR-2) and to gNB2 (eLLR-3 and eLLR-4) are shown together with examples of cross-link interference (CLI) between the gNBs and between the UEs of the two cells; and

FIG. 8 shows a schematic of two wireless communication systems (WCS1 and WCS2), wherein in each WCS, a number of bi-directional communication links are shown—for example, UE1a<->gNB1 and UE2b<->gNB2—wherein the eLLR created by the UE is shown while now, additional eLLRs created in a first WCS are provided to a second WCS.

### DETAILED DESCRIPTION OF THE INVENTION

Equal or equivalent elements or elements with equal or equivalent functionality are denoted in the following description by equal or equivalent reference numerals.

Method steps which are depicted by means of a block diagram and which are described with reference to said block diagram may also be executed in an order different from the depicted and/or described order. Furthermore, method steps concerning a particular feature of a device may be replaceable with said feature of said device, and the other way around.

In the following, reference will be made to a first device and to a second device, wherein one of the first and second devices may act as a transmitter of an inventive enriched link-level report, while the other one of the first and second devices may act as a receiver of an inventive enriched link-level report. The invention covers both devices, i.e. the inventive device can be either one of a receiving device that receives an enriched link-level report or a transmitting device that transmits an enriched link-level report.

Furthermore, the inventive devices may be configured to be operated in a wireless communication system. Even though the inventive devices may comprise at least one wireless channel, the claimed communication link between these two devices may use a different channel and the communication link itself may either be configured as a wireless or a wired connection. The same holds for the link via which the inventive enriched link-level report is transferred between two inventive devices, i.e. said link may also be based on either a wireless or a wired technology.

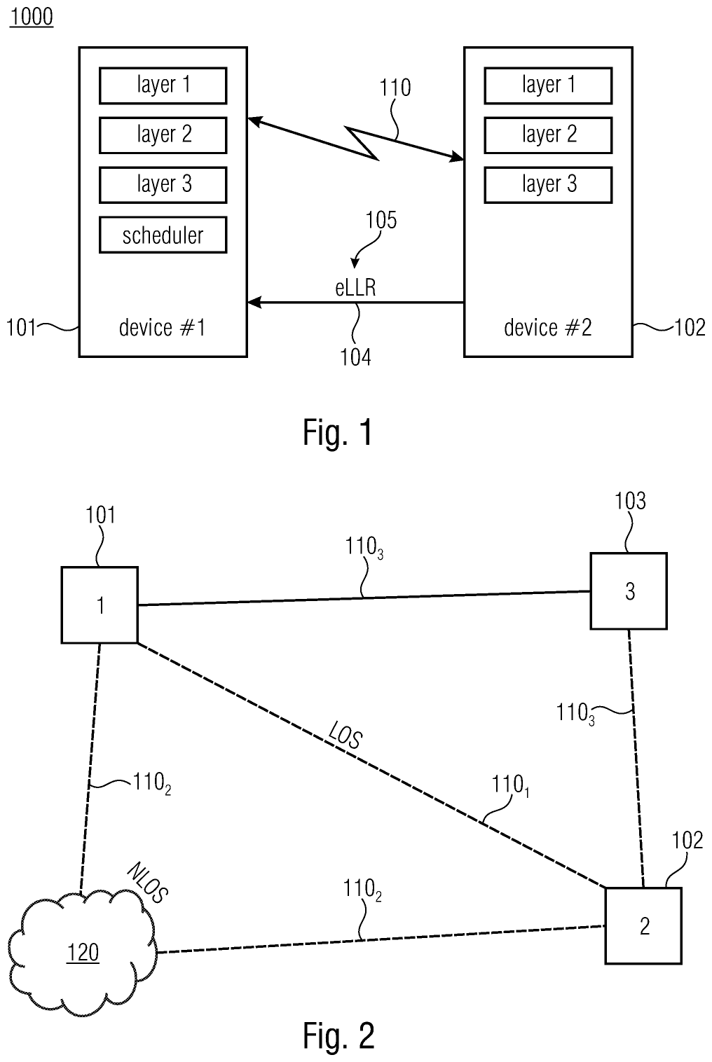

FIG. 1 shows a first exemplary embodiment according to the herein described invention. A first device 101 and a second device 102 may be operated in a wireless communication system 1000. A communication link 110 may exist between the first and the second devices 101, 102. The communication link 110 may be either wired or wireless. The communication link 110 may be a bi-directional communication link.

In addition to said communication link 110, a further link 104 may exist between the first and the second device 101, 102. Said further link 104 may also be either wired or wireless. A link-level report 105 may be transferred between the first and second devices 101, 102 via said further link 104. The term “transfer” as used herein includes transmitting and receiving data. The further link 104, via which the enriched link-level report 105 is transferred, may be a unidirectional link. Alternatively, the further link 104 may be a bidirectional wireless link between the first and second devices 101, 102.

One of the first and second devices 101, 102 is configured to transmit the enriched link-level report, while the other one of the first and second devices 101, 102 is configured to receive the enriched link-level report 101, 102. Depending on whether the respective device 101, 102 acts as a transmitter or as a receiver of the enriched link-level report 105, the respective device 101, 102 may provide different functionalities and/or operation modes. Thus, the following description with reference to the appended figures may describe the invention from a perspective of a transmitter of an enriched link-level report 105 as well as from a perspective of a receiver of the enriched link-level report 105.

The above mentioned further link 104, via which the enriched link-level report 105 is transferred, may be operated on a different channel than the communication link 110. However, it is to be noted that the link-level report 105, even though being transferred via the further link 104, may contain information being related with the communication link 110. For example, the link-level report 105 may comprise at least one of an information about
a root cause of a change in link-level performance of the communication link 110,
a measure to change link-level performance of the communication link 110, and
a trend and/or an anticipated behavior of link-level performance of the communication link 110.

The inventive link-level report 105 and the information contained therein will be explained in more detail further below. However, it shall already be mentioned that the inventive link-level report 105 comprises more information about the wireless communication link 110 compared to known devices. Accordingly, the inventive link-level report 105 may also be referred to as an enhanced or enriched link-level report 105, which will be abbreviated herein by eLLR.

The inventive enriched link-level report 105 (eLLR) may be used for at least one of: the wireless communication link 110 itself, other links, and network optimization in general. Furthermore, the combination of eLLR(s) 105 from multiple links offers additional benefits to individual links and the network. Therefore, the invention may provide the additional benefit of an eLLR 105 to become a part of minimization of drive testing (MDT).

In this non-limiting example as shown in FIG. 1, the second device 102 may transmit an enriched link-level report 105 to the first device 101. Accordingly, the second device 102 may act as a transmitter and may transmit the enriched link-level report 105 via the further link 104, while the first device 101 may act as a receiver and may receive said enriched link-level report 105 via the further link 104.

In an alternative embodiment (not shown), the first device 101 may transmit an enriched link-level report 105 to the second device 102. Accordingly, the first device 101 may act as a transmitter and may transmit the enriched link-level report 105 via the further link 104, while the second device 102 may act as a receiver and may receive said enriched link-level report 105 via the further link 104.

In either of the above described embodiments, one of the first and second devices 101, 102 may act as a transmitter of the enriched link-level report 105, while the other one of the first and second devices 101, 102 may act as a receiver of the enriched link-level report 105. Accordingly, the inventive device 101, 102 is capable of receiving and/or transmitting the enriched link-level report 105 (eLLR).

The eLLR 105 may be transferred between the first and second devices 101, 102 via the further link 104 that is separate from the communication link 110. Stated in more general terms, the eLLR 105 may be provided by a means that is different to that used to establish a wireless or wired communication link 110 between the first and second devices 101, 102. Additionally or alternatively, the eLLR 105, or at least a portion thereof, may be transferred between the first and second devices 101, 102 via the communication link 110.

As mentioned above, the further link 104 may be wireless or wired. As an example for a wired connection, two networks may be considered, each operated by a different operator, in which link-level reports 105 are shared between the basestations of each operator through their core networks and the use of an inter-operator-core bridge connection which is not necessarily wireless.

Furthermore, in either of the above described embodiments, the communication link 110 may be configured as a direct end-to-end link between the first device 101 as a first end and the second device 102 as a second end.

FIG. 2 shows an alternative non-limiting example, in which a third device 103 is involved in the communication between the first device 101 and the second device 102. In this non-limiting example, a communication in a multipath scenario is exemplarily depicted.

For example, the first device 101 may be a transmitter for transmitting a signal via the communication link 110 to the second device 102. Accordingly, the second device 102 may be a receiver for receiving said transmitted signal via the communication link 110. The second device 102 may receive the signal via multiple propagation paths that may also be referred to as multipath components. For instance, a first path 1101 (or first multipath component) of the communication link 110 may be a direct path, also referred to as a line-of-sight path (LOS), between the first and second devices 101, 102. A second path 1102 (or second multipath component) may be an indirect path, also referred to as a non-line-of-sight path (NLOS), wherein the signals may be, for instance, reflected at an obstruction (e.g.

a tree) 120 or the like.

The third device 103 may provide a third propagation path 1103 (or third multipath component) between the first device 101 and the second device 102. In this case, the communication link 110 may be an indirect link between the first device 101 as one end and the second device 102 as another end with the third device 103 in between.

However, compared to the above mentioned obstruction (e.g. a tree) 120, the third device 103 may be directly involved in the communication between the first and second devices 101, 102. For example, the third device 103 may be configured to passively forward signals between the first and second devices 101, 102. In this case, the third device 103 may comprise a passive reflector, for example. Additionally or alternatively, the third device 103 may be configured to actively relay signals between the first and second devices 101, 102. In this case, the third device 103 may receive signals from one of the first and second devices 101, 102, may optionally process said signals, and transmit the received (and optionally processed) signals to the other one of the first and second devices 101, 102.

In either case, be it an active or a passive involvement of the third device 103 in the communication between the first and second devices 101, 102, the third device 103 may be a configurable contributor to the communication link 110. For instance, even if the third device 103 may be passively involved, e.g. if it comprises a passive reflector, the third device 103 may be configurable in order to make a contribution to the communication link 110. For instance, the third device 103 may be configured to turn or swivel the passive reflector in order to aim at the receiving device, or in more general terms, in order to change (e.g. enhance) the signal propagation path 1103 being provided by the third device 103. Accordingly, the third device 103 makes a contribution to the communication link 110.

Since the third device 103 may be a configurable contributor that contributes to the communication link 110, it may be distinguished from a simple obstacle (e.g. a tree) 120 which is not configurable. In other words, a configurable contributor 103 may be distinguished from an obstacle 120 in that at least one property of said configurable contributor (e.g. the third device) 103 may be intentionally used / exploited. Such a property may be, for instance, at least one of a reflection, phase shift, polarization, etc. The third device 103 may, for example, be a repeater, a RIS, etc.

Still with reference to FIG. 2, it shall be mentioned that the above described multipath scenario concerns the multipath propagation of the communication link 110 between the first and second devices 101, 102. That is, at least one path 1103 of the communication link 110 can be routed via the third device 103. The aforementioned further link 104, via which the inventive enriched link-level report (eLLR) 105 may be transferred between the first and second devices 101, 102, may still further be provided by means of a direct end-to-end link between the first and second devices 101, 102, i.e. without involvement of a configurable contributor 103. However, multipath propagation may also be possible when transferring the enriched link-level report 105 via the further link 104. Accordingly, the first device 101 may transmit an eLLR directly to the second device 102, or the other way around.

An eLLR 105 being transferred between the first device 101 to the second device 102 may contain information about the communication link 110 established between the first and second devices 101, 102. Accordingly, in the above described multipath scenario, the eLLR 105 may optionally also contain information about the third path 1103 of the communication link 110 and/or information about any effects that the third device 103 may have on one or more other paths 1101, 1102 of the communication link 110. Some examples and embodiments regarding said multipath scenarios shall be given further below.

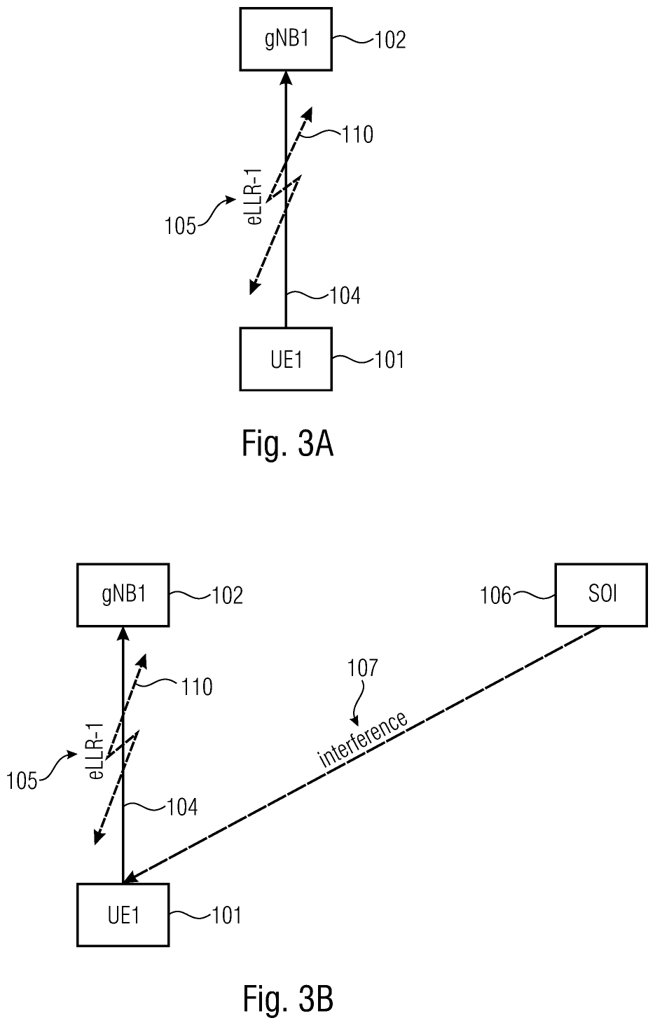

FIG. 3A shows a further non-limiting example of a direct end-to-end link 110 between the first and second devices 101, 102. At this point it shall be mentioned that everything that is explained herein with reference to direct end-to-end links 110 may also be applicable to multipath links with two or more multipath components 1101, 1102, . . . , 110n, and vice versa.

In the non-limiting example as shown in FIG. 3A, a first device 101 may be a User Equipment (UE) inside a wireless communication system, and the second device 102 may be a base station, e.g. a gNB in 5G terms. In this non-limiting example, the communication link 110 may be a bidirectional wireless communication link between the UE 101 and the gNB 102, wherein user data and/or control data may be mapped to a wireless carrier being transmitted either in uplink, i.e. from the UE 101 to the gNB 102, or in downlink, i.e. from the gNB 102 to the UE 101.

As can further be seen in the non-limiting example of FIG. 3A, a unidirectional wireless link 104 may be provided between the first device (UE) 101 and the second device (gNB) 102 via which an enriched link-level report 105 (eLLR) may be transferred between the two devices 101, 102. In this non-limiting example, the UE 101 may act as a transmitter of the enriched link-level report 105, and the gNB 102 may act as a receiver of the enriched link-level report 105.

FIG. 3B shows a scenario in which a source of interference (SOI) 106 may additionally be present. The source of interference 106 may cause some sort of interference 107 to the communication link 110 between the first device 101 (UE1) and the second device 102 (gNB1). This interference 107 may have an impact on the link-level performance (e.g. quality and/or quantity of data transmission) of the communication link 110. This impact may be either a positive impact leading to an enhanced link-level performance of the communication link 110 or a negative impact leading to a degradation of the link-level performance of the communication link 110. In either way, the link-level performance of the communication link 110 may vary or change based on the presence or absence of interference 107. In other words, the link-level performance of the communication link 110 may change or vary between a substantially interference-free state without significant interference and an interfered state in the presence of a source of interference 106. The link-level performance may also change in response to a change in the interference itself, for example if interference increases or decreases, then the link-level performance may change or vary accordingly, e.g. by enhancing or degrading.

The transmitter of the eLLR 105, e.g. the inventive first device 101, may be configured to include information about a current link-level performance and/or information about a change in link-level performance into the enriched link-level report 105. Accordingly, the inventive first device 101 may be configured to obtain the enriched link-level report (eLLR) 105 by creating the eLLR 105 by itself, and to transmit the created eLLR 105 to the second device 102. On the other hand, the inventive second device 102 may be configured to receive the eLLR 105 and to retrieve information from said received eLLR 105.

In this case, the first device 101 would be a transmitter of an eLLR 105, while the second device 102 may be a receiver of an eLLR 105. For simplicity of explanation, this notation shall be maintained in the following description, i.e. the first device 101 may represent a transmitter of an eLLR 105, while the second device 102 may represent a receiver of an eLLR 105. Of course, it may also be the other way around.

Accordingly, a receiver of the eLLR 105 may be configured to obtain the eLLR 105 by receiving the eLLR 105 from the transmitter. In this case, the inventive second device 102 may receive the eLLR 105 and may retrieve information contained in the received eLLR 105.

As mentioned above, the link-level performance of the communication link 110 may vary or change based on a current (environmental) situation, e.g. in case of the presence of a source of interference 106. Thus, the interference caused by the source of interference 106 may be regarded as a root cause for the variation or change in the link-level performance. Of course, there may be some other kinds of root causes that may cause a change or variation in the link-level performance.

According to the inventive concept, one information contained in the enriched link-level report (eLLR) 105 may be an information about a root cause of a change in link-level performance of the communication link 110. For example, the inventive first device 101, that may act as a transmitter of the eLLR 105, may be configured to include into the eLLR 105, as part of the information about the root cause of a change in link-level performance, at least one of an information
whether the root cause for the change in link-level performance is of stochastic nature or of deterministic nature,
whether the root cause for the change in link-level performance has a temporal dependency such that the link-level performance varies over time,
whether the root cause for the change in link-level performance has a spectral dependency such that the link-level performance varies with varying frequencies,
whether the root cause for the change in link-level performance has a spatial dependency such that the link-level performance varies with varying signal distribution in space,
whether the root cause for the change in link-level performance has a locational dependency such that the link-level performance varies at different locations of the transmitter of the eLLR 105 (e.g. the first device 101) and/or of any further device 102, 103 being involved in a communication via the communication link 110,
whether the root cause for the change in link-level performance has an orientation-dependency such that the link-level performance varies with varying orientation of the transmitter of the eLLR 105 (e.g. the first device 101) and/or of any further 102, 103 device being involved in a communication via the communication link 110,
whether the root cause for the change in link-level performance has a power-level-dependency such that the link-level performance varies with varying receive and/or transmission power levels of the transmitter of the eLLR 105 (e.g. the first device 101) and/or of any further device 102, 103 being involved in a communication via the communication link 110,
whether the root cause for the change in link-level performance has a bandwidth dependency such that the link-level performance varies with varying occupied bandwidth,
whether the root cause for the change in link-level performance has a polarization dependency such that the link-level performance varies with varying polarizations of an antenna of the transmitter of the eLLR 105 (e.g. the first device 101) and/or of any further device 102, 103 being involved in a communication via the communication link 110,
whether the root cause for the change in link-level performance follows a Gaussian distribution, and
an information about the mean and/or variance of a Gaussian distribution of the change in link-level performance.

From a perspective of a receiver of an eLLR 105, e.g. from a perspective of the inventive second device 102, said receiver may be configured to retrieve from the received eLLR 105, as part of the information about the root cause of a change in link-level performance of the communication link 110, at least one of an information:
whether the root cause for the change in link-level performance is of stochastic nature or of deterministic nature, whether the root cause for the change in link-level performance has a temporal dependency such that the link-level performance varies over time,
whether the root cause for the change in link-level performance has a spectral dependency such that the link-level performance varies with varying frequencies,
whether the root cause for the change in link-level performance has a spatial dependency such that the link-level performance varies with varying signal distribution in space,
whether the root cause for the change in link-level performance has a locational dependency such that the link-level performance varies at different locations of the receiver of the eLLR 105 (e.g. the second device 102) and/or of any further device 101, 103 being involved in a communication via the communication link 110,
whether the root cause for the change in link-level performance has an orientation-dependency such that the link-level performance varies with varying orientation of the receiver of the eLLR 105 (e.g. the second device 102) and/or of any further device 101, 103 being involved in a communication via the communication link 110,
whether the root cause for the change in link-level performance has a power-level-dependency such that the link-level performance varies with varying receive and/or transmission power levels of the receiver of the eLLR 105 (e.g. the second device 102) and/or of any further device 101, 103 being involved in a communication via the communication link 110,
whether the root cause for the change in link-level performance has a bandwidth dependency such that the link-level performance varies with varying occupied bandwidth,
whether the root cause for the change in link-level performance has a polarization dependency such that the link-level performance varies with varying polarizations of an antenna of the receiver of the eLLR 105 (e.g. the second device 102) and/or of any further device 101, 103 being involved in a communication via the communication link 110,
whether the root cause for the change in link-level performance follows a Gaussian distribution, and
an information about the mean and/or variance of a Gaussian distribution of the change in link-level performance.

Furthermore, the inventive first and second devices 101, 102 may be configured to determine the nature of the root cause for the variation or change in link-level performance as being of either stochastic nature or deterministic nature. For example, the inventive device 101, 102 may classify a determined root cause as being
deterministic (predictive performance variation); or
stochastic (random, unpredictable performance variation).

The transmitter of the eLLR 105 (e.g. the first device 101) may classify by itself whether a root cause is of stochastic nature or deterministic nature. It may include this information into the eLLR 105.

The receiver of an eLLR 105, e.g. the inventive second device 102, may retrieve said information from the eLLR 105, i.e. the second device 102 may retrieve an information whether the root cause was classified as being of stochastic or deterministic nature. Additionally or alternatively, the second device 102 may classify by itself whether a root cause is of stochastic or deterministic nature based on any relevant information contained in the eLLR 105.

A deterministic variation in the link-level performance may derive from a deterministic or known event, situation, behaviour, or the like causing a repeatable behaviour of the wireless communication link 110 and, thus, causing a repeatable performance variation. A non-limiting example for a deterministic event could be an obstruction in the transmission path leading to a known and repeatable behaviour of the wireless communication link 110, for instance a known and repeatable level of degradation.

A stochastic variation in link-level performance may derive from a stochastic event, situation, behaviour, or the like causing an unpredictable or non-repeatable behaviour of the wireless communication link 110 and, thus, causing an unpredictable performance variation. A non-limiting example for a stochastic event could be noise or (fast) fading leading to an unknown behaviour of the wireless communication link 110 and, thus, to an unknown or non-repeatable amount of change or variation in link-level performance.

When determining and/or classifying the nature of a root cause as being either deterministic or stochastic, the inventive device 110 may be configured to consider variations over time and/or frequency of the changing link-level performance.

This is an important difference over known CQI values that only represent the result of an averaging process. For example, a CQI value associated with a given BWP does not disclose variations over time and/or frequency. In this case, two CQI values may look similar even though the underlying statistics (e.g. the root cause for the changing or varying link-level performance) could be different. Furthermore, while some RBs within the BWP may be below the average CQI in either a deterministic or a stochastic manner, this nature is not revealed in the CQI itself, due to its averaging nature.

The present invention, however, does provide feedback about the nature of the root cause of changing or varying link-level performance such that an inventive device 101, 102 may be enabled to provide counter measures against varying or changing link-level performance. For instance, the inventive device 101, 102 may adapt its receive and/or transmission strategy appropriately. In brief, as long as changing link-level performance (for example, packet errors) follow a (specific) stochastic behaviour, the wireless communication link 110 can be operated with means optimized for such (packet error) behaviour. However, in case of feedback describing a deterministic nature of changing link-level performance (e.g. packet errors), a transmit strategy, a receive strategy and/or a combined transmit/receive strategy can be suitably adapted to come to grips with the nature of the root cause.

Generally, a root cause may be responsible for a change or a variation in the link-level performance of the communication link 110. Thus, it may be desirable to alleviate or compensate said change in link-level performance. For example, if a source of interference 106 may cause a degraded link-level performance, it is of advantage to provide adequate counter measures for compensating or alleviating said link-level degradation. These counter measures may depend on whether the root cause is stochastic or deterministic.

Stated in more general terms, if a root cause for the change in link-level performance may be determined as being of deterministic nature, then the inventive device 101, 102 may be configured to alleviate or compensate the change in link-level performance by applying at least one counter measure out of a first set of counter measures. In turn, if a root cause for the change in link-level performance may be determined as being of stochastic nature, then the inventive device 101, 102 may be configured to alleviate or compensate the change in link-level performance by applying at least one counter measure out of a second set of counter measures. The contents of the first set of counter measures and the second set of counter measures may be different.

For example, the first set of counter measures for alleviating or compensating a root cause of deterministic nature may comprise at least one of the following counter measures that the transmitter of an eLLR 105, e.g. the inventive first device 101, may apply:
varying one or more communication link parameters,
varying a scheduling of the communication link 110,
varying a beam coordination and/or a beamforming of an antenna of the first and/or second device 101,
varying an alignment of a directive antenna of the first device 101,
varying a spatial orientation of the first device 101,
varying a position of the first device 101,
switching to a different base station.

It is to be noted that beamforming may comprise a radiation pattern adaptation (forming) including main lobes, side lobes and nulls.

For example, the first set of counter measures for alleviating or compensating a root cause of deterministic nature may comprise at least one of the following counter measures that the receiver of an eLLR 105, e.g. the inventive second device 102, a may apply:
varying one or more communication link parameters,
varying a scheduling of the communication link 110,
varying a beam coordination and/or a beamforming of an antenna of the second device 102,
varying an alignment of a directive antenna of the second device 102,
varying a spatial orientation of the second device 102,
varying a position of the second device 102,
switching to a different base station.

Summarizing, one information that may be contained in an inventive enriched link-level report (eLLR) 105 may be an information about a measure to change link-level performance of the wireless communication link 110.

As mentioned above, the inventive devices 101, 102 may be configured to apply counter measures from a different second set of counter measures in case the root cause was classified as being of stochastic nature. Accordingly, the second set of counter measures for alleviating or compensating a root cause of stochastic nature may comprise at least one of the following counter measures that at least one of the transmitter of an eLLR 105, e.g. the inventive first device 101, and the receiver of the eLLR 105, e.g. the inventive second device 102, may apply:
interleaving,
spreading,
randomized beam sweeping,
deterministic beam sweeping,
cyclic delay diversity,
hopping in at least one of time, frequency and space,
change of coding scheme,
space time codes, and
repetition coding.

Of course, if the root cause was classified as being (at least partly) of stochastic nature and (at least partly) of deterministic nature, then the inventive devices 101, 102 may be configured to apply at least one counter measure from the first set of counter measures and additionally at least one counter measure from the second set of counter measures.

The above mentioned examples are non-exhaustive. Many more counter measures may be provided by the inventive devices 101, 102 in order to alleviate or compensate a change in link-level performance that is caused by a certain root cause. Stated in more general terms, one could say that the inventive devices 101, 102 may provide one or more counter measures by adapting or changing their respective strategy of transferring (i.e. receiving and/or transmitting) data via the communication link 110 and/or by changing their respective mode of operating the communication link 110.

For example, in case the inventive device 101, 102 may transmit information (user and/or control data) via the communication link 110, then the device 101, 102 may adapt or change its transmission strategy as a counter measure for alleviating or compensating the changed link-level performance caused by a certain root cause. In case the inventive device 101, 102 may receive information (user and/or control data) via the communication link 110, then the device 101, 102 may adapt or change its receive strategy. Of course, both inventive devices 101, 102 may mutually adapt or change their respective transmit and receive strategies, i.e. the inventive devices 101, 102 may perform a combined transmit/receive strategy adaptation.

For instance, two flying airships (first and second devices 101, 102) may serve as a non-limiting example for an adaptation of a receive strategy, a transmit strategy or a combined transmit/receive strategy. These two airships 101, 102 may be connected to each other via a directed wireless communication link 110. Said communication link 110 may comprise a certain link-level performance that may not change if both airships 101, 102 were constantly flying next to each other. However, if one of the two airships 101, 102 may change its orientation and/or position relative to the other one of the two airships 101, 102, or if a source of interference 106 may be present, this may change the link-level performance. In order to alleviate or compensate said change in link-level performance, at least one of the two airships 101, 102 may adapt or change its strategy of receiving or transmitting data via the communication link 110, respectively. In other words, a change of position or orientation may be of relevance to derive a strategy to balance and/or improve the directive wireless communication link 110.

In a further embodiment, the transmitter of an eLLR 105, e.g. the inventive first device 101, may be configured to report to the receiver of the eLLR 105, e.g. to the inventive second device 102, the one or more counter measures that it has applied. For example, said report may be sent via the inventive enriched link-level report (eLLR) 105, for instance as part of the information about the measure to change the link-level performance of the wireless communication link 110.

In yet a further embodiment, the transmitter of an eLLR 105, e.g. the inventive first device 101, may be configured to explicitly request and/or instruct the receiver of the eLLR 105, e.g. the inventive second device 102, to apply one or more counter measures for alleviating or compensating the change in link-level performance. Said explicit request and/or instruction may be contained in the link-level report 105 as part of the information about the measure to change the link-level performance.

Said information about the measure may optionally also contain information about one or more measures that any further device, e.g. the above described third device 103, has applied or will apply in order to alleviate or compensate the change in link-level performance caused by a certain root cause.

For example, with reference to FIG. 2, the second device 102 may report to the first device 101 about a change in link-level performance of the communication link 110 that may have been caused by a certain root cause. For doing so, the second device 102 may transmit an eLLR 105 to the first device 101, wherein said enriched link-level report 105 may contain information about a root cause that caused a change or variation of the link-level performance of the communication link 110 between the first and second devices 101, 102. As mentioned above, the communication link 110 may comprise one or more multipath components 1101, 1102, 1103, an information of which may be contained in the information about the communication link 110. Accordingly, the eLLR 105 may contain information about effects stemming from the third device 103.

Then, the first device 101 may transmit an eLLR 105 to the second device 102, wherein said eLLR 105 may contain information about a measure that the second device 102 may apply in order to alleviate or compensate the change or variation in link-level performance. Additionally or alternatively, this eLLR 105 may contain information about a measure that the third device 103 may apply in order to alleviate or compensate the change or variation in link-level performance.

For example, the transmitter of an eLLR 105, e.g. the first device 101, may instruct the second device 102 and/or any further device being involved in the communication via the communication link 110, e.g. the third device 103, to apply at least one of the counter measures of the above mentioned first and/or second set of counter measures. In particular, at least one of the following measures may be requested and/or instructed to be applied:
varying one or more communication link parameters, varying one or more communication link relevant properties, e.g. reflection angle, phase relationship,
varying a scheduling of the communication link 110,
varying a beam coordination and/or a beamforming of an antenna of the second device 102 and/or of the third device 103,
varying an alignment of a directive antenna of the second device 102 and/or a directivity of one or more incoming and/or outgoing multi-path components 1101, 1102, 1103 of the third device 103,
varying a spatial orientation of the second device 102 and/or of incoming and/or outgoing multi-path components 1101, 1102, 1103 of the third device 103,
varying a position of the second device 102 and/or of the third device 103, and
performing a hand-over procedure.

It is to be noted that beamforming comprises a radiation pattern adaptation (forming) including main lobes, side lobes and nulls.

As mentioned before, the third device 103 may be an active device, e.g. an active relay. In this case, the transmitter of the eLLR 105, e.g. the first device 101, may instruct the second device 102 and/or the active third device 103, to apply at least one of the following counter measures:
interleaving,
spreading,
randomized beam sweeping,
deterministic beam sweeping,
cyclic delay diversity,
hopping in at least one of time, frequency and space,
change of coding scheme,
space time codes, and
repetition coding.

If the third device 103 may be a passive device, e.g. a passive reflector or the like, then the transmitter of the eLLR 105, e.g. the first device 101, may instruct the passive third device 103, to apply at least one of the following counter measures:
applying a phase shift,
applying a change of reflection angles,
applying a change of one or more incoming and/or outgoing communication paths with respect to at least one of:
   a direction,
   a polarization,
   a beam width/divergence,
   a spectral localization, and
   amplitudes (power) and/or phase relations.

Accordingly, with continued reference to FIG. 2, the transmitter of an eLLR 105, e.g. the first device 101, may instruct and/or request the receiver of the eLLR 105, e.g. the second device 102, and/or any further device being involved in the communication, e.g. the third device 103, to apply at least one of the above mentioned measures to alleviate or compensate the change or variation in link-level performance.

In a further embodiment, the second device 102 may report to the first device 101 about the effect of the counter measures that were applied by the first device 101 and/or second device 102 and/or third device 103. Thus, the receiver of the eLLR 105, e.g. the second device 102, may provide a feedback to the transmitter of the eLLR 105, e.g. to the first device 101. The second device 102 may do so by sending a further eLLR 105 to the first device 101 in which said feedback information may be contained.

As a further embodiment, the inventive devices 101, 102 may be configured to predict a trend or future behaviour of the link-level performance of the wireless communication link 110. For example, the first device 101 may be configured to transmit an eLLR 105 to the second device 102, the eLLR 105 containing an information about a predicted future link-level performance of the wireless communication link 110. Said information may be contained in the eLLR 105, for instance as part of the information about a trend and/or an anticipated behavior of the link-level performance of the wireless communication link 110.

The first device 101 may not only predict a future link-level performance but it may optionally also derive a new transmit and/or receive strategy which the first device 101 is going to perform in the future as a predicted or precautionary counter measure for counteracting a predicted change in link-level performance. In other words, the transmitter of the eLLR 105, e.g. the first device 101, may provide future counter measures that it is going to or will apply in the future in order to alleviate or compensate the change in link-level performance.

Thus, according to an embodiment, the transmitter of the eLLR 105, e.g. the first device 101, may be configured to report to the receiver of the eLLR 105, e.g. to the second device 102, one or more counter measures that the first device 101 is going to apply in the future for alleviating or compensating the change in link-level performance, wherein said report may be sent via the eLLR 105, for instance as part of the information about the measure to change the link-level performance of the wireless communication link 110.

Additionally or alternatively, the transmitter of the eLLR 105, e.g. the first device 101, may be configured to send to the receiver of the eLLR 105, e.g. to the second device 102, and/or to any further device being involved in the communication via the communication link 110, e.g. to the third device 103, an explicit request and/or instruction to apply one or more counter measures in the future for alleviating or compensating the change in link-level performance. Said explicit request and/or instruction may be contained in the eLLR 105, for instance as part of the information about the measure to change the link-level performance of the wireless communication link 110.

Summarizing, an eLLR 105 may contain information relating to a counter measure that a device 101, 102, 103 a) has performed, b) will perform, or c) suggests or requests that it or another device will perform. For example, when looking at a single link 104 as shown in FIGS. 1 to 3B, an inventive eLLR 105 obtained at each end (i.e. at the first device 101 and/or the second device 102) can be used to:
determine and/or predict a problem/root cause of a change in link-level performance (e.g. poor link performance), and/or
derive a (predicted) transmit and/or receive strategy to improve link performance including choice of link parameters, scheduling, beamforming, orientation, position, alignment etc.

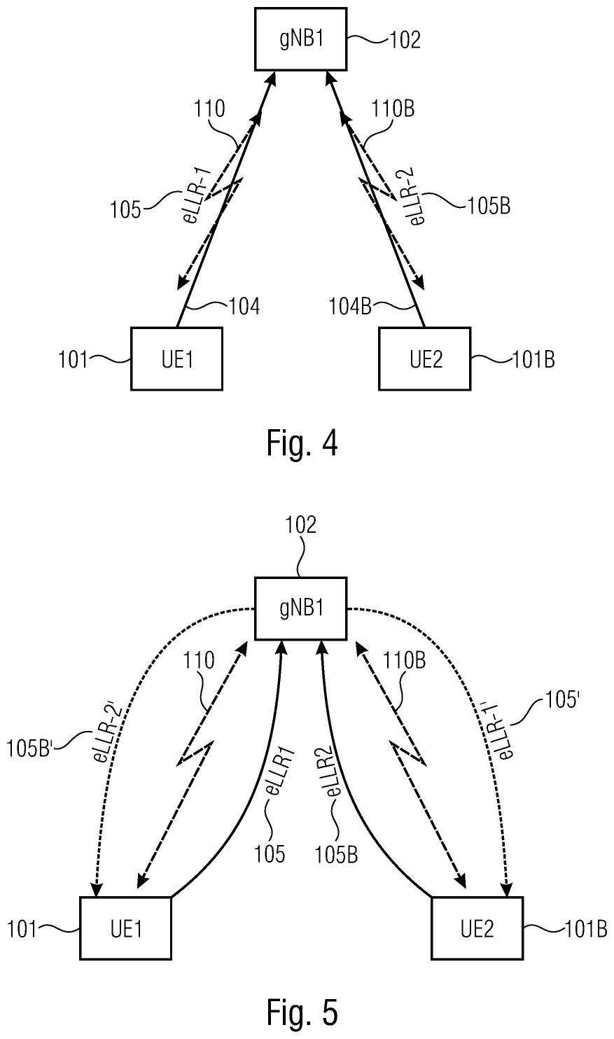

A further embodiment is shown in FIG. 4, wherein the above described two inventive devices 101, 102 and a further device 101B are shown. In this non-limiting example, one of the two inventive devices 101, 102, e.g. the inventive first device 101 may be configured as a User Equipment (UE1) residing in a wireless communication system, and the other one of the two inventive devices 101, 102, e.g. the inventive second device 102, may be configured as a base station (gNB1).

The further device 101B may be a further User Equipment (UE2) in said wireless communication system. A first communication link 110 may be established between the first device 101 (UE1) and the second device 102 (gNB1). A second communication link 110B may be established between the second device 102 (gNB1) and the further device 101B (UE2).

A first eLLR 105 may be transmitted via the above described further link 104 by a first transmitter, e.g. by the inventive first device 101, to the receiver of the eLLR 105, e.g. to the inventive second device 102. A second eLLR 105B may be transmitted via a second further link 104B by a second transmitter, e.g. by the further device 101B, to the receiver of the second eLLR 105B, e.g. to the inventive second device 102. Accordingly, both eLLRs 105, 105B may be received by the eLLR-receiver, e.g. by the inventive second device 102.

The second link-level report 105B may comprise at least one of an information about
a root cause of a change in link-level performance of the second communication link 110B,
a measure to change link-level performance of the second communication link 110B, and
a trend and/or an anticipated behavior of link-level performance of the second communication link 110B.

FIG. 5 shows a further embodiment, wherein the second device 102 may be configured to relay and/or forward the first eLLR, or at least a portion thereof, to the further device 101B, which is indicated by means of dashed lines 105′ labelled with eLLR-1′. Additionally or alternatively, the second device 102 may be configured to relay and/or forward the second eLLR 105B, or at least a portion thereof, to the first device 101, which is indicated by means of dashed lines 105B′ labelled with eLLR-2′.

The second further link 104B, via which the second eLLR 105B may be transmitted, may have the same or identical functionalities as the further link 104 between the first and second devices 101, 102, via which the eLLR 105 may be transmitted. Thus, everything that is described herein with respect to the further link 104 and to the eLLR 105 also holds for the second further link 104B and the second eLLR 105B, and vice versa. However, while the eLLR 105 may contain information related with the communication link 110 between the first and second devices 101, 102, the second eLLR 105B may contain information related with the second communication link 110B between the further device 101B and at least one of the first and second devices 101, 102.

For example, at least one of the following features may be provided in the embodiments as shown in FIGS. 4 and 5:
For a first communication link 110, the eLLR 105 obtained at one or both ends (first and/or second device 101, 102) of the first communication link 110 together with one or more eLLRs 105B obtained from other devices (one or more further devices 103) being related with respective other communication links 110B can be used to:
   Determine a problem/root cause of poor link performance of a first communication link 110 and/or other communication links 110B, e.g. the eLLR 105, 105B may include information about certain properties, characteristics and patterns in the interference observed from one or more sources of interference. Such patterns may relate to the localization of interference or its occurrence in time (slots, OFDM-symbols), spectrum(frequency) and/or space.
   Derive a transmit/receive strategy to improve link performance improve of a first communication link 110 and/or other communication links 110B including choice of link parameters, scheduling, beamforming, orientation, position, alignment etc.
   Forward the eLLRs 105, 105B to other network entities (e.g. to one or more further devices 103) as required, as depicted in FIG. 5.

According to a further embodiment, the receiver of two or more eLLRs 105, 105B, e.g. the inventive second device 102, may check whether the received eLLRs 105, 105B may be conflicting. For example, the second device 102 may check whether the counter measures as reported in each of the eLLRs 105, 105B are conflicting and/or whether they are sufficiently coordinated to be non-conflicting and/or whether the counter measures are suitable for remedying the root cause.

If the device 102 may detect that two or more of the received eLLRs 105, 105B are conflicting and/or not sufficiently coordinated and/or not suitable, then the device 102 may be configured to
intervene before said counter measures are applied, and/or
coordinate the reported counter measures, and/or
orchestrate the reported counter measures, and/or
compensate the reported counter measures, and/or . instruct and/or request the second device 101 or any other device 101B to coordinate and/or orchestrate and/or compensate the reported counter measures.

As exemplarily described above with reference to FIG. 3B, a root cause for a change in link-level performance may be caused by a source of interference 106. In the following, some non-limiting examples of different kinds of interferences will be described that can be handled by means of the inventive eLLR 105.

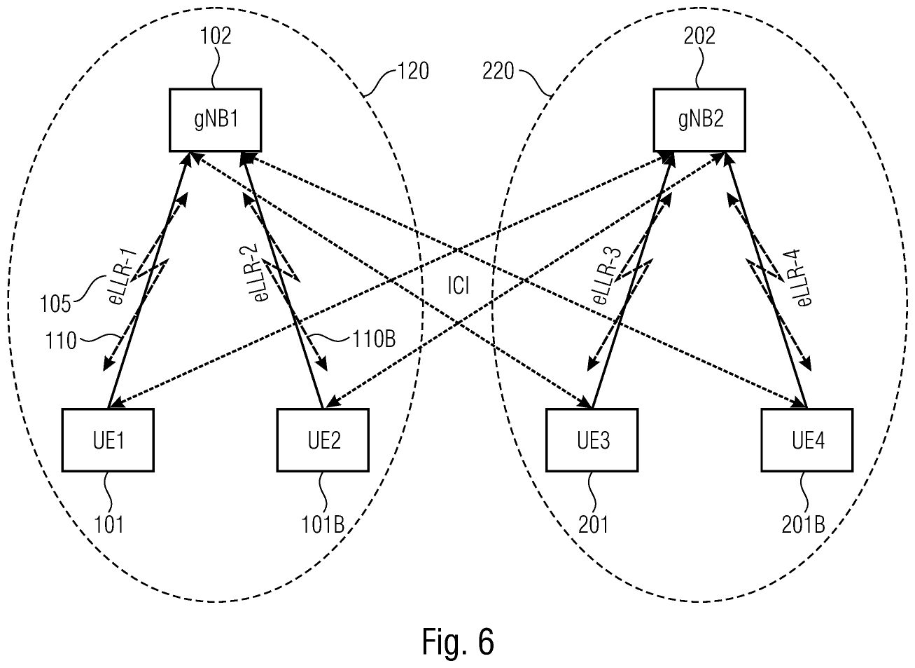

As a first example, so-called inter-cell interference (ICI) shall be described as one non-limiting example for a root cause that can be reported within an eLLR 105. As exemplarily depicted in FIG. 6, said inter-cell interference may be caused between the transmitter of an eLLR 105, e.g. the inventive first device 101, residing in a first wireless communication cell 120 and at least one third device 201, 201B, 202 residing in a different second wireless communication cell 220. Additionally or alternatively, inter-cell interference may be caused between the receiver of an eLLR 105, e.g. the inventive second device 102, residing in a first wireless communication cell 120 and at least one third device 201, 201B, 202 residing in a different second wireless communication cell 220.

Still with reference to FIG. 6, an inter-cell-interference (ICI) between a base station 102 inside a first cell 120 and a UE 201, 201B inside a different second cell 220 may be the root cause for a change in the link-level performance of one of the communication links 110, 110B inside the first cell 120. For example, one of the inventive first and second devices 101, 102 may be configured as a base station inside a first cell 120. The base station may provide said first cell 120. A third device 201, 201B inside a different second cell 220 may be configured as a UE. In this exemplary scenario, one of the UEs 201, 201B in the second cell 220 may act as a source of interference that somehow affects the receiver of the eLLR 105, in this case the inventive second device 102 being configured as a base station. This ICI may be the root cause for a change (e.g. degrading or enhancement) of the link-level performance of one of the communication links 110, 110B inside the first wireless communication cell 120.

A second example that is depicted in FIG. 6 shows an inter-cell-interference (ICI) between a User Equipment 101, 101B inside the first cell 120 and a base station 202 inside the different second cell 220. In this exemplary scenario, the base station 202 in the second cell 220 may act as a source of interference that somehow affects the transmitter of the eLLR 105, in this case one of the devices 101, 101B being configured as a UE. This ICI may be the root cause for a change (e.g. degrading or enhancement) of the link-level performance of one of the communication links 110, 110B inside the first wireless communication cell 120.

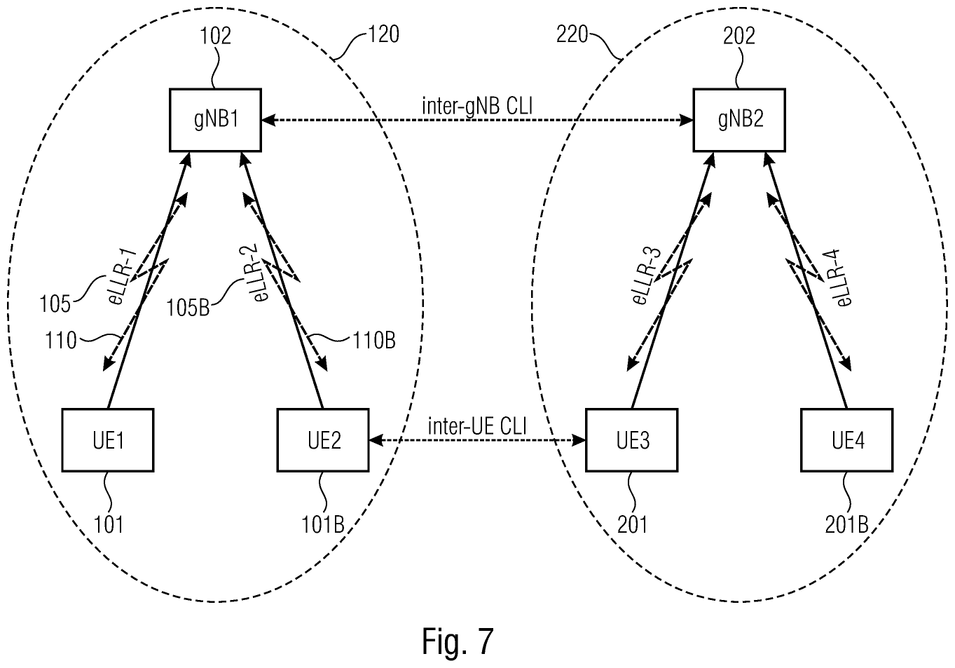

FIG. 7 shows a further example for a root cause that can be reported within an eLLR 105, wherein said root cause is a so-called cross-link-interference (CLI). In a first example, an Inter-gNB CLI between a base station 102 inside a first cell 120 and a base station 202 inside a different second cell 220 may be the root cause for a change in the link-level performance of one of the communication links 110, 110B inside the first cell 120. For example, one of the inventive first and second devices 101, 102, e.g. the second device 102, may be configured as a base station inside the first cell 120. The base station 102 may provide said first cell 120. A third device 202 inside the different second cell 220 may be configured as a base station that may provide said second cell 220. In this exemplary scenario, the base station 202 in the second cell 220 may act as a source of interference that somehow affects the receiver of the eLLR 105, in this case the inventive second device 102 being configured as a base station. This Inter-gNB CLI may be the root cause for a change (e.g. degrading or enhancement) of the link-level performance of one of the communication links 110, 110B inside the first wireless communication cell 120.

A second example that is depicted in FIG. 7 shows an Inter-UE CLI between a User Equipment 101, 101B inside the first cell 120 and a User Equipment 201, 201B inside the different second cell 220. In this exemplary scenario, one of the UEs 201, 201B in the second cell 220 may act as a source of interference that somehow affects the transmitter of the eLLR 105, in this case one of the devices 101, 101B being configured as a UE. This Inter-UE CLI may be the root cause for a change (e.g. degrading or enhancement) of the link-level performance of one of the communication links 110, 110B inside the first wireless communication cell 120.

Summarizing, for multiple links, the one or more eLLRs 105 obtained at one or both ends (devices 101, 102) of the links can be used to:
Determine a problem/root cause of poor network performance of a gNB or group of gNBs
Derive a transmit/receive strategy to improve network/cell performance of a gNB and/or a group of gNBs including choice of link/network parameters, scheduling, beamforming, orientation, position, alignment etc.,
Forward the one or more eLLRs to other network entities as required.

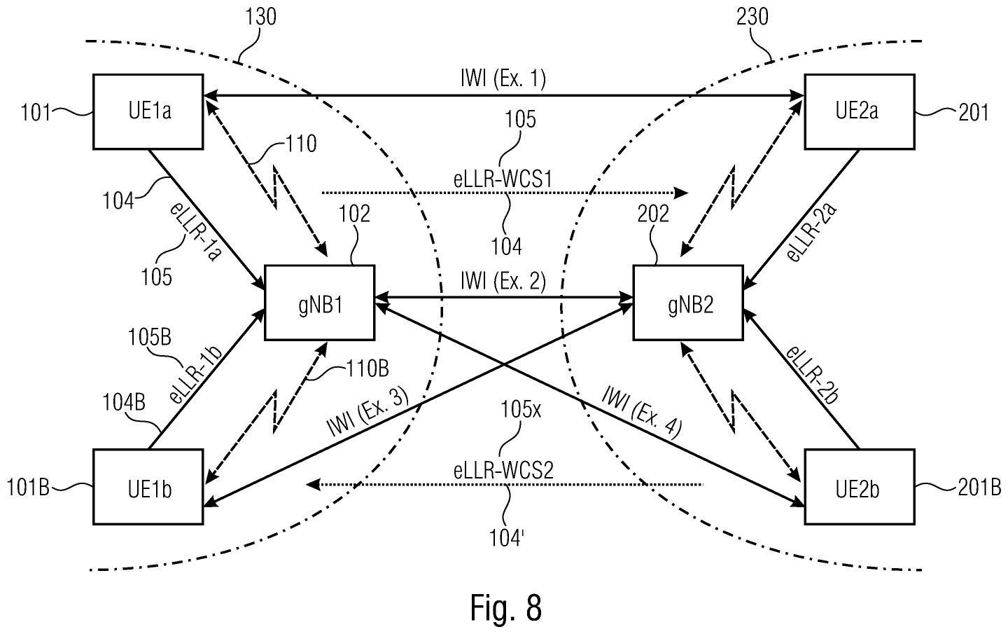

FIG. 8 shows a further example for a root cause that can be reported within an eLLR 105, wherein said root cause is a so-called inter-system interference, or more particular an Inter-Wireless Communication System-Interference (IWI). In this example, the inventive first and second devices 101, 102, i.e. the transmitter of an eLLR 105 and the receiver of an eLLR 105, may be entities of a first wireless communication system (WCS1) 130. A different second wireless communication system (WCS2) 230 may comprise one or more third devices 201, 201B, 202 that may act as a base station or a UE. In an IWI-scenario, the root cause for a change in link-level performance, the information of which is provided in the link-level report 105, may be based on an inter-system interference between the device 101, 102 residing in the first wireless communication system 130 and at least one third device 201, 201B, 202 residing in the different second wireless communication system 230.

A first non-limiting example may be an IWI between a UE of the first wireless communication system 130 and one or more UEs 201, 201B of the different second wireless communication system 230. For instance, the transmitter of an eLLR 105, e.g. the inventive first device 101, may be configured as a user equipment being served by a wireless communication cell within the first wireless communication system 130. The receiver of the eLLR 105, e.g. the inventive second device 102, may be configured as a base station inside the first wireless communication system 130. The base station 102 may provide a wireless communication cell (FIG. 7) inside the first wireless communication system 130. A different second wireless communication system 230 may comprise one or more third devices 201, 201B, 202 that may act as a UE or a base station, respectively. According to said first example of an Inter-Wireless Communication System-Interference (IWI-Ex. 1) one of the UEs 201, 201B of the second system 230 may act as a source of interference that somehow affects the transmitter of the eLLR 105, in this case one of the devices 101, 101B being configured as a UE. This IWI may be the root cause for a change (e.g. degrading or enhancement) of the link-level performance of one of the communication links 110, 110B inside the first wireless communication system 130.

A second non-limiting example may be an IWI between a base station 102 of the first wireless communication system 130 and one or more base stations 202 of the different second wireless communication system 230. For instance, the receiver of the eLLR 105, e.g. the inventive second device 102, may be configured as a base station inside the first wireless communication system 130. One or more of the third devices 201, 201B, 202, e.g. the device 202, may act as a base station inside the second wireless communication system 230. According to said second example of an Inter-Wireless Communication System-Interference (IWI-Ex. 2) the base station 202 of the second system 230 may act as a source of interference that somehow affects the receiver of the eLLR 105, in this case the inventive second device 102 being configured as a base station. This IWI may be the root cause for a change (e.g. degrading or enhancement) of the link-level performance of one of the communication links 110, 110B inside the first wireless communication system 130.

A third non-limiting example may be an IWI between a UE 101, 101B of the first wireless communication system 130 and one or more base stations 202 of the second wireless communication system 230. For instance, a transmitter of the eLLR 105, e.g. the inventive first device 101, 101B, may be configured as a UE inside the first wireless communication system 130. One or more of the third devices 201, 201B, 202, e.g. the device 202, may act as a base station inside the second wireless communication system 230. According to said third example of an Inter-Wireless Communication System-Interference (IWI-Ex. 3) the base station 202 of the second system 230 may act as a source of interference that somehow affects the transmitter of the eLLR 105, in this case the inventive first device 101, 101B being configured as a UE. This IWI may be the root cause for a change (e.g. degrading or enhancement) of the link-level performance of one of the communication links 110, 110B inside the first wireless communication system 130.

A fourth non-limiting example may be an IWI between a base station 102 of the first wireless communication system 130 and one or more UEs 201, 201B inside the second wireless communication system 230. For instance, a receiver of the eLLR 105, e.g. the inventive second device 102, may be configured as a base station inside the first wireless communication system 130. One of the third devices 201, 201B, 202, e.g. the devices 201, 201B, may act as UEs inside the second wireless communication system 230. According to said fourth example of an Inter-Wireless Communication System-Interference (IWI-Ex. 4) the UEs 201, 201B of the second system 230 may act as a source of interference that somehow affects the receiver of the eLLR 105, in this case the inventive second device 102 being configured as a base station. This IWI may be the root cause for a change (e.g. degrading or enhancement) of the link-level performance of one of the communication links 110, 110B inside the first wireless communication system 130.

It is to be mentioned that, even though not explicitly depicted in FIG. 8, the above described Inter-Cell-Interference (ICI) and/or Cross-Link-Interference (CLI) scenarios may appear within each WCS 130, 230 in addition to the described examples of inter-WCS-interference (IWI).

In a further embodiment, enriched link-level reports (eLLRs) may be transferred between entities of the first and second wireless communication systems 130, 230. For example, the inventive first and second devices 101, 102 may be configured to transmit an eLLR 105 that was obtained in the first wireless communication system 130 to at least one third device 201, 201B, 202 residing in the different second wireless communication system 230. This scenario is depicted in FIG. 8 by means of dashed lines 104 labelled with eLLR-WCS1. Additionally or alternatively, the inventive first and second devices 101, 102 may be configured to receive an eLLR 105x that was obtained in the second wireless communication system 230 from at least one third device 201, 201B, 202 residing in the different second wireless communication system 230. This scenario is depicted in FIG. 8 by means of dashed lines 104′ labelled with eLLR-WCS2.

According to an embodiment, the first wireless communication system 130 may be of a first type of radio access network (RAN), and the second wireless communication system 230 may be of a different second type of a radio access network (RAN). Alternatively, the first wireless communication system 130 and the second wireless communication system 230 may be of a same type of a radio access network (RAN).

Summarizing, for multiple links within multiple WCSs 130, 230, the eLLRs 105 obtained in a first WCS 130 and the eLLRs 105x obtained in a second WCS 230 may be used to:
Determine a problem/root cause of poor network performance of a gNB or group of gNBs in the either or both WCSs 130, 230,
Derive a transmit/receive strategy to improve network/cell performance of a gNB and/or a group of gNBs including choice of link/network parameters, scheduling, beamforming, orientation, position, alignment etc. in either or both WCSs 130, 230.

An inventive eLLR 105 can be further processed by other network entities that a) comprise the affected communication link itself, b) form part of a cell, c) are deemed to be quasi-collocated (QCLed) with one or more other users, d) are within a given wireless communication system (WCS), or d) are forwarded or exchanged with other WCSs 130, 230 either of the same type of radio access network (RAN) or of different types of RAN. An inventive eLLR 105 can be stored, recalled, requested, processed, combined and separated by entities which reside inside or outside of any given WCS 130, 230 or in combination with permutations thereof.

In all of the herein described examples and embodiments, the inventive device 101, 102 may be configured to process the eLLRs 105 from one or more network entities and forward a processed result to other network entities as required. Additionally or alternatively, the type and mode of message forwarding can follow the same eLLR framework as used to collect the eLLRs. The aforementioned processing may include amongst other things:
identification of common or specific patterns;
deterministic or stochastic categorisation of input-output relations; and
decision formed from a consensus etcetera.

The following bullet points shall serve to provide a brief overview of the operations that can be performed by the inventive device 101, 102:

1. Observe a wireless link [by a first network entity, e.g. first device 101]

2. Create an enriched link-level report (eLLR) 105 [e.g. by the first device 101], the eLLR 105 may contain:
a. description of a symptom,
b. optionally, an auto-diagnosis [self-determination]
c. optionally, an auto-prognosis [self-prediction]
d. optionally, report on actions taken and/or intended actions [by the first device 101]
e. optionally, suggest/request an action to be taken [by a second network entity, e.g. by the second device 102]

3. Transmit eLLR(s) 105 to the second device 102 (eLLR-receiver)

4. Process the eLLR(s) 105 by the second device 102 (eLLR-receiver), that may result in:
a. a diagnosis of a root cause based on information contained in one or more eLLR(s) 105 only OR using additional information in combination with that contained in the one or more eLLR(s) 105, e.g. location, time, location-cum-time =quasi-collocated (QCL), directional information, etc.
b. and optionally, a prognosis of anticipated symptoms
5. Optionally, forward the one or more eLLR(s) 105 from the second device 102 (eLLR-receiver) to one or more third network entities (e.g. to the further device 101B):
a. in any of the following forms:
   i. Unprocessed (raw) form
   ii. Processed:
      1. selectively;
      2. aggregated; or
      3. combined with other information (see 4a).
b. wherein the third network entities may not be necessarily QCLed with:
   i. one another; or
   ii. the first device 101 and/or the second device 102,
c. wherein the third network entities are determined to be QCLed with:
   i. one another; or
   ii. the first device 101 and/or the second device 102,

6. derive a new transmit strategy [treatment] by the second device 102 (eLLR-receiver) or any other network entity, including:
a. following an action suggested/requested by the first device 101 (eLLR-transmitter);
b. optionally, informing the first device 101 of the new transmit strategy; and
c. optionally, suggesting/ request matching action(s) to be taken [by the first device 101].

7. optionally, create an eLLR 105 [by the second device 102 (eLLR-receiver)].

In all of the herein described examples and embodiments, the inventive devices 101, 102 may use an acknowledgment scheme for acknowledging and/or not-acknowledging a successful receipt of user data and/or control data that was transferred via the communication link 110. For instance, the inventive first device 101 may transmit a message containing user and/or control data to the inventive second device 102 via the communication link 110. If the second device 102 successfully received the message, then it may transmit an acknowledged indicator (ACK) to the first device 101. If the message was not, or not correctly received, then the second device 102 may transmit a non-acknowledged indicator (NACK) to the first device 101. This may correspond to known acknowledgement schemes like automatic repeat request (ARQ) or hybrid ARQ (HARQ).

However, the inventive devices 101, 102 may be configured to enrich conventional acknowledgment information. For instance, if a message was not correctly received due to a root cause of deterministic nature, the inventive devices 101, 102 may transfer a new not-acknowledged indicator (e.g. D-NACK) indicating towards the transmitter of the message that the message was unsuccessfully received due to a root cause of deterministic nature. In turn, if a message was not correctly received due to a root cause of stochastic nature, the inventive devices 101, 102 may transfer a new not-acknowledged indicator (e.g. S-NACK) indicating towards the transmitter of the message that the message was unsuccessfully received due to a root cause of stochastic nature.

Thus, according to an embodiment, the inventive devices 101, 102 may be configured to use an acknowledgement scheme for reporting to each other whether data transferred via their communication link 110 was successfully received or not. If the data was not successfully received due to a root cause of stochastic nature, then one of the inventive devices 101, 102, e.g. the second device 102 as an intended recipient of the data, may be configured to transmit to the other one of the inventive devices 101, 102, e.g. to the first device 101 as the intended transmitter of the data, a not-acknowledged indicator of a first type (S-NACK) indicating a root cause of stochastic nature. Additionally or alternatively, if the data was not successfully received due to a root cause of deterministic nature, then one of the inventive devices 101, 102, e.g. the second device 102 as an intended recipient of the data, may be configured to transmit to the other one of the inventive devices 101, 102, e.g. to the first device 101 as the intended transmitter of the data, a not-acknowledged indicator of a second type (D-NACK) indicating a root cause of deterministic nature.

Said not-acknowledged indicators (D-NACK, S-NACK) may be transferred between the inventive devices 101, 102 by means of the enriched link-level report (eLLR) 105.

Furthermore, a confidence level can be used to weight the response, e.g. 60% D-NACK/40% S-NACK. The D-NACK and S-NACK are provided in an enhanced link-level report (eLLR) 105 that might also contain information relating to the action a device a) has performed, b) will perform, or c) suggests or requests that it or another device will perform.

Accordingly, one of the inventive devices 101, 102, e.g. the second device 102 as an intended recipient of the data, may be configured to determine by which amount the root cause is of stochastic nature and by which amount the root cause is of deterministic nature, and to transmit a weighted version of the not-acknowledged indicators (e.g. 40% S-NACK/60% D-NACK) to the other one of the inventive devices 101, 102, e.g. to the first device 101 as the intended transmitter of the data.

The application of the inventive solution disclosed herein is applicable to any type of wireless communication system (WCS), regardless of its topology which might include, for example, point-to-point, point-to-multi-point, daisy-chained (linear), ring, star, mesh, any hybrid combination thereof and ad-hoc networks.

The application of the inventive solution further includes the distribution and exchange of one or more eLLRs 105 between links that form part of one or more WCSs 130, 230 and/or links that are known to have interdependencies.

The benefits of the invention are summarized as follows:
Enriched reporting on monitored links
Opportunity to use reports for faster and better-informed root cause analysis and therefrom, derivation of counter measures
Further-enhanced communication strategies based on eLLRs
Early detection of link degradation leading to possible avoidance and thus derivation of suitable/appropriate countermeasures
Faster link-recovery
Reduced feedback overhead
Signalling of suggested countermeasures
Signalling of intended actions

Summarizing, an inventive device 101, 102, e.g. a network entity such as a base station (e.g. a gNB), a user equipment (UE) or some other wired or wireless device, may comprise the means to determine the nature of an error or a mechanism that creates a change in link-level performance, for instance some form of enhancement or degradation to a service, performance, functionality, quality and the such like. The nature of such errors or mechanisms affecting the communication link 110 between two or more network entities 101, 102 can be classified as being either:
Deterministic (predictive performance enhancement/degradation); or
Stochastic {random, unpredictable behaviour}.

The inventive concept may be based on an examination of structures within the inventive devices 101, 102 that provide insights of root causes. Examples are not limited to include: decoder's soft bits; de-mapper's estimates; de-interleaver; de-multiplexer; frequency, phase and/or time alignment; equalizer settings; CSI-estimator; SNR; SINR; CNR; CINR; ICI; CLI; ACLR; LNA and/or PA gain settings; inter-RAT interference; inter-frequency interference; geolocation; speed; orientation; transmission and/or reception mode; time; etc.

According to the inventive principle, a link level report may be enriched with information, for example:
ACK/NACK→ACK/D-NACK and ACK/S-NACK
   Example 1: H-ARQ+(Stochastic/deterministic) (1-bit enrichment). Can be multi-layered or hierarchical or quantized.
   Example 2: Wideband SINR feedback (CLI)+SINR variance or marking of extremes (peaks)

Signalling of the inventive eLLR 105 may be done to the network (Uplink—UL) and/or from the network (Downlink—DL). In case one of the inventive devices 101, 102 may be configured as a user equipment (UE), the UE may be configured by means of, e.g. RRC, ME.

The inventive concept may be used for
Adapting Tx/Rx strategies in UL/DL
Changing of Tx/Rx filters (beamformers)
Diversity vs. multiplexing
Changing of resource mapping/scheduling/channel
MCS, K-repetition H-ARQ
Gathering of system/network performance KPIs: e.g. task a group of UEs to deliver eLLRs (MDT like jobs)

In the following, some exemplary embodiments will be mentioned:

1. A device (101, 102) for use in a wireless communication system (130),
the device (101, 102) comprising a communication link (110) to at least a second device (101, 102),
wherein the device (101, 102) is configured to transmit and/or receive a link-level report (105), and/or
wherein the device (101, 102) is configured to control the communication link (110) by means of the link-level report (105) or configured to be controlled based on information contained in the link-level report (105),
the link-level report (105) comprising at least one of an information about
   a root cause of a change in link-level performance of the communication link (110),
   a measure to change link-level performance of the communication link (110), and
   a trend and/or an anticipated behavior of link-level performance of the communication link (110).

2. The device (101, 102) according to embodiment 1,
wherein the communication link (110) is a bi-directional communication link between the device (101, 102) and the second device (101, 102).

3. The device (101, 102) according to embodiment 1 or 2,
wherein the communication link (110) is a direct end-to-end link between the device (101, 102) and the second device (101, 102), or
wherein the communication link (110) is an indirect link between the device (101, 102) as one end and the second device (101, 102) as another end with a third device (103) in between, wherein said third device (103) is involved in a communication between the first and second devices (101, 102) via the communication link (110).

4. The device (101, 102) according to embodiment 3,
wherein the third device (103) is involved in said communication by providing at least one path (1103) of the communication link (110) via which a communication between the device (101) and the second device (102) takes place, and
wherein the third device (103) is a configurable contributor to the communication link (110) between the first and second devices (101, 102).

5. The device (101, 102) according to embodiment 4,
wherein the third device (103) is involved in said communication by relaying or forwarding signals between the first and second devices (101, 102) via the at least one path (1103) of the communication link (110) that is provided by the third device (103).

6. The device (101, 102) according to any one of embodiments 1 to 5,
wherein the device (101, 102) has a second link (104) with the second device (101, 102) via which the link-level report (105) is transmitted to or received from the second device (101, 102),
wherein said second link (104) is different from the communication link (110) between the device (101, 102) and the second device (101, 102).

7. The device (101, 102) according to embodiment 6,
wherein the second link (104), via which the link-level report (105) is received or transmitted, is a unidirectional link between the device (101, 102) and the second device (101, 102).

8. The device (101) according to any one of embodiments 1 to 7,
wherein the device (101) is configured to obtain the link-level report (105) by creating the link-level report (105) by itself, and to transmit the created link-level report (105) to the second device (102).

9. The device (101) according to embodiment 8,
wherein the device (101) is configured to include into the link-level report (105), as part of the information about the root cause of a change in link-level performance, at least one of an information
   whether the root cause for the change in link-level performance is of stochastic nature or of deterministic nature,
   whether the root cause for the change in link-level performance has a temporal dependency such that the link-level performance varies over time,
   whether the root cause for the change in link-level performance has a spectral dependency such that the link-level performance varies with varying frequencies,
   whether the root cause for the change in link-level performance has a spatial dependency such that the link-level performance varies with varying signal distribution in space,
   whether the root cause for the change in link-level performance has a locational dependency such that the link-level performance varies at different locations of the device (101) and/or of any further device (102, 103) being involved in a communication via the communication link (110),
   whether the root cause for the change in link-level performance has an orientation-dependency such that the link-level performance varies with varying orientation of the device (101) and/or of any further device (102, 103) being involved in a communication via the communication link (110),
   whether the root cause for the change in link-level performance has a power-level-dependency such that the link-level performance varies with varying receive and/or transmission power levels of the device (101) and/or of any further device (102, 103) being involved in a communication via the communication link (110),
   whether the root cause for the change in link-level performance has a bandwidth dependency such that the link-level performance varies with varying occupied bandwidth,
   whether the root cause for the change in link-level performance has a polarization dependency such that the link-level performance varies with varying polarizations of an antenna of the device (101) and/or of any further device (102, 103) being involved in a communication via the communication link (110),
   whether the root cause for the change in link-level performance follows a Gaussian distribution, and
   an information about the mean and/or variance of a Gaussian distribution of the change in link-level performance.

10. The device (101) according to one of embodiments 8 or 9,
wherein the device (101) is configured to classify a root cause for the change in link-level performance as being of either stochastic nature or deterministic nature.

11. The device (101) according to embodiment 10,
wherein the device (101) is configured to consider variations over time and/or frequency of the changing link-level performance when classifying the root cause.

12. The device (UE1) according to one of embodiments 10 or 11, wherein
if the root cause for the change in link-level performance is classified as being of deterministic nature, then the device (UE1) is configured to provide a counter measure for alleviating or compensating the change in link-level performance by applying at least one of the following measures:
   varying one or more communication link parameters,
   varying a scheduling of the communication link,
   varying a beam coordination and/or a beamforming of an antenna of the device (UE1),
   varying an alignment of a directive antenna of the device (UE1),
   varying a spatial orientation of the device (UE1),
   varying a position of the device (UE1),
   switching to a different base station.

13. The device (UE1) according to any one of embodiments 10 to 12, wherein
if the root cause for the change in link-level performance is classified as being of stochastic nature, then the device (UE1) is configured to provide a counter measure for alleviating or compensating the change in link-level performance by applying at least one of the following measures:
   interleaving,
   spreading,
   randomized beam sweeping,
   deterministic beam sweeping,
   cyclic delay diversity,
   hopping in at least one of time, frequency and space,
   change of coding scheme,
   space time codes, and
   repetition coding.

14. The device (101) according to any one of embodiments 10 to 12, wherein
if the root cause for the change in link-level performance is classified as being of deterministic and stochastic nature, then the device (101) is configured to provide a counter measure for alleviating or compensating the change in link-level performance by applying at least one of the following measures:
   varying one or more communication link parameters,
   varying a scheduling of the communication link,
   varying a beam coordination and/or a beamforming of an antenna of the device (101),
   varying an alignment of a directive antenna of the device (101),
   varying a spatial orientation of the device (101),
   varying a position of the device (101),
   switching to a different base station
and to provide a further counter measure for alleviating or compensating the change in link-level performance by applying at least one of the following measures:
   interleaving,
   spreading,
   randomized beam sweeping,
   deterministic beam sweeping,
   cyclic delay diversity,
   hopping in at least one of time, frequency and space,
   change of coding scheme,
   space time codes, and
   repetition coding.

15. The device (101) according to any one of embodiments 12 to 14,
wherein the device (101) is configured to report to the second device (102) the one or more counter measures that the device (101) has applied in order to alleviate or compensate the change in link-level performance caused by a certain root cause,
wherein said report is sent via the link-level report (105) as part of the information about the measure to change the link-level performance of the communication link (110).

16. The device (101) according to one of embodiments 1 to 15,
wherein the device (101) is configured to request and/or instruct the second device (102) and/or any further device (103) being involved in a communication via the communication link (110)
   to apply one or more counter measures for alleviating or compensating the change in link-level performance caused by a certain root cause,
wherein the corresponding request and/or instruction is sent via the link-level report (105) as part of the information about the measure to change link-level performance of the communication link (110).

17. The device (101) according to embodiment 16,
wherein the device (101) is configured to request and/or instruct at least one of the second device (102) and said further device (103) to apply at least one of the following measures:
   varying one or more communication link parameters,
   varying one or more communication link relevant properties, e.g. reflection angle, phase relationship,
   varying a scheduling of the communication link (110),
   varying a beam coordination and/or a beamforming of an antenna of the second device (102) and/or said further device (103) being involved in the communication via the communication link (110),
   varying an alignment of a directive antenna of the second device (102) and/or a directivity of one or more incoming and/or outgoing multi-path components (1101, 1102, 1103) of said further device (103) being involved in the communication via the communication link (110),
   varying a spatial orientation of the second device (102) and/or of incoming and/or outgoing multi-path components (1101, 1102, 1103) of said further device (103) being involved in the communication via the communication link (110),
   varying a position of the second device (102) and/or of said further device (103) being involved in the communication via the communication link (110), and
   performing a hand-over procedure.

18. The device (101) according to embodiment 16 or 17,
wherein the device (101) is configured to request and/or instruct at least one of the second device (102) and said further device (103) to apply at least one of the following measures:
   interleaving,
   spreading,
   randomized beam sweeping,
   deterministic beam sweeping,
   cyclic delay diversity,
   hopping in at least one of time, frequency and space,
   change of coding scheme,
   space time codes, and
   repetition coding,
and/or wherein the device (UE1) is configured to request and/or instruct said further device (103) being involved in a communication via the communication link to apply at least one of the following measures:
applying a phase shift,
applying a change of reflection angles,
applying a change of one or more incoming and/or outgoing communication paths with respect to at least one of:
   a direction,
   a polarization,
   beam width/divergence,
   a spectral localization, and amplitudes (power) and/or phase relations.

19. The device (101) according to one of embodiments 8 to 18,
wherein the device (101) is configured to predict a future behaviour of the link-level performance of the communication link (110), and
configured to send a predicted link-level performance to the second device (102) via the link-level report (105) as a part of the information about a trend and/or an anticipated behavior of link-level performance of the communication link (110).

20. The device (101) according to embodiment 19,
wherein the device (101) is configured to report to the second device (102)
   one or more measures that the device (101) is going to apply in the future for alleviating or compensating a change in link-level performance caused by a certain root cause,
wherein said report is sent via the link-level report (105) as part of the information about the measure to change the link-level performance of the communication link (110).

21. The device (101) according to one of embodiments 19 or 20,
wherein the device (101) is configured to request and/or instruct the second device (102) and/or any further device (103) being involved in a communication via the communication link (110)
   to apply one or more measures in the future for alleviating or compensating a change in link-level performance caused by a certain root cause,
wherein the corresponding request and/or instruction is sent via the link-level report (105) as part of the information about the measure to change link-level performance of the communication link (110).

22. The device (102) according to any one of embodiments 1 to 7,
wherein the device (102) is configured to obtain the link-level report (105) by receiving the link-level report (105) from the second device (102).

23. The device (102) according to embodiment 22,
wherein the device (102) is configured to retrieve from the received link-level report (105), as part of the information about the root cause of a change in link-level performance of the communication link (110), at least one of an information:
   whether the root cause for the change in link-level performance is of stochastic nature or of deterministic nature,
   whether the root cause for the change in link-level performance has a temporal dependency such that the link-level performance varies over time,
   whether the root cause for the change in link-level performance has a spectral dependency such that the link-level performance varies with varying frequencies,
   whether the root cause for the change in link-level performance has a spatial dependency such that the link-level performance varies with varying signal distribution in space,
   whether the root cause for the change in link-level performance has a locational dependency such that the link-level performance varies at different locations of the device (102) and/or of any further device (101, 103) being involved in a communication via the communication link (110),
   whether the root cause for the change in link-level performance has an orientation-dependency such that the link-level performance varies with varying orientation of the device (102) and/or of any further device (101, 103) being involved in a communication via the communication link (110),
   whether the root cause for the change in link-level performance has a power-level-dependency such that the link-level performance varies with varying receive and/or transmission power levels of the device (102) and/or of any further device (101, 103) being involved in a communication via the communication link (110),
   whether the root cause for the change in link-level performance has a bandwidth dependency such that the link-level performance varies with varying occupied bandwidth,
   whether the root cause for the change in link-level performance has a polarization dependency such that the link-level performance varies with varying polarizations of an antenna of the device (102) and/or of any further device (101, 103) being involved in a communication via the communication link (110),
   whether the root cause for the change in link-level performance follows a Gaussian distribution, and
   an information about the mean and/or variance of a Gaussian distribution of the change in link-level performance.

24. The device (102) according to one of embodiments 22 or 23,
wherein the device (102) is configured to classify, based on the information contained in the link-level report (105), a root cause for the change in link-level performance as being of stochastic nature or deterministic nature,
or to derive from the information contained in the received link-level report (105) whether a root cause for the change in link-level performance is of stochastic nature or deterministic nature.

25. The device (102) according to embodiment 24,
wherein the device (102) is configured to consider variations over time and/or frequency of the changing link-level performance when classifying the root cause.

26. The device (102) according to one of embodiments 24 or 25, wherein
if the root cause for the change in link-level performance is classified as being of deterministic nature,
then the device (102) is configured to provide a counter measure for alleviating or compensating the change in link-level performance by applying at least one of the following measures:
   varying one or more communication link parameters,
   varying a scheduling of the communication link (110),
   varying a beam coordination and/or a beamforming of an antenna of the device (102),
   varying an alignment of a directive antenna of the device (102),
   varying a spatial orientation of the device (102),
   varying a position of the device (102),
   switching to a different base station.

27. The device (102) according to any one of embodiments 24 to 26, wherein
if the root cause for the change in link-level performance is classified as being of stochastic nature,
then the device (102) is configured to provide a counter measure for alleviating or compensating the change in link-level performance by applying at least one of the following measures:
   interleaving,
   spreading,
   randomized beam sweeping,
   deterministic beam sweeping,
   cyclic delay diversity,
   hopping in at least one of time, frequency and space,
   change of coding scheme,
   space time codes, and
   repetition coding.

28. The device (102) according to one of embodiments 22 to 27,
wherein the device (102) is configured to receive an explicit request and/or instruction from the second device (101)
to provide a counter measure for alleviating or compensating the change in link-level performance,
wherein said explicit request and/or instruction is contained in the received link-level report (105) as part of the information about the measure to change the link-level performance of the communication link (110).

29. The device (102) according to embodiments 28,
wherein the device (102) is configured to provide the counter measure according to the received request and/or instruction by applying at least one of the following measures:
   varying one or more communication link parameters,
   varying a scheduling of the communication link (110),
   varying a beam coordination and/or a beamforming of an antenna of the device (102),
   varying an alignment of a directive antenna of the device (102),
   varying a spatial orientation of the device (102),
   varying a position of the device (102),
   switching to a different base station,
   interleaving,
   spreading,
   randomized beam sweeping,
   deterministic beam sweeping,
   cyclic delay diversity,
   hopping in at least one of time, frequency and space,
   change of coding scheme,
   space time codes, and
   repetition coding.

30. The device (102) according to one of embodiments 22 to 29,
wherein the device (102) is configured to retrieve from the received link-level report (105), as a part of the information about the measure to change the link-level performance, a report from the second device (101) reporting about one or more measures that the second device (101) and/or any further device (103) being involved in a communication via the communication link (110), has applied in order to alleviate or compensate a change in link-level performance caused by a certain root cause.

31. The device (102) according to one of embodiments 22 to 30,
wherein the device (102) is configured to retrieve from the received link-level report (105), as a part of the information about a trend and/or an anticipated behavior of link-level performance of the communication link (110), a predicted future behaviour of the link-level performance of the communication link (110).

32. The device (102) according to embodiment 31,
wherein the device (102) is configured to receive from the second device (101) an explicit request and/or instruction
   to apply one or more counter measures in the future for alleviating or compensating a change in link-level performance caused by a certain root cause.

33. The device (102) according to one of embodiments 31 or 32,
wherein the device (102) is configured to retrieve from the received link-level report (105) a report from the second device (101) reporting about
one or more actions that the second device (101) and/or any further device (103) being involved in a communication via the communication link (110) s going to perform in the future for alleviating or compensating a change in link-level performance caused by a certain root cause.

34. The device (101, 102) according to any one of embodiments 1 to 33,
wherein the device (101, 102) is configured to transmit the link-level report (105) to and/or receive the link-level report (105) from the second device (101, 102), wherein the second device (101, 102)
   resides in the same wireless communication system (130) as the device (101, 102) itself and is served by the same cell as the device (101, 102), and/or
   resides in the same wireless communication system (130) as the device (101, 102) itself but is served by a different cell than the device (101, 102), and/or
   resides in a different wireless communication system (230) than the device (101, 102).

35. The device (102) according to any one of embodiments 1 to 34,
wherein, if the device (102) receives the link-level report (105) from the second device (101), then the device (102) is configured to
   relay or forward the received link-level report (105), or at least a portion thereof, to any third device (103) residing in the same wireless communication system (130) as the device (102) itself and being served by the same cell as the device (102), and/or
   relay or forward the received link-level report (105), or at least a portion thereof, to any third device (103) residing in the same wireless communication system (130) as the device (102) itself but being served by a different cell than the device (102), and/or
   relay or forward the received link-level report (105), or at least a portion thereof, to any third device (103) residing in a different wireless communication system (230) than the device (102).

36. The device (101, 102) according to any one of embodiments 1 to 35,
wherein the device (101, 102) is configured to use an acknowledgement scheme for reporting to the second device (101, 102) whether data transferred via the communication link (110) was successfully received by the device (101, 102) or not, wherein
if the data was not successfully received due to a root cause of stochastic nature,
   then the device (101, 102) is configured to transmit to the second device (101, 102) a not-acknowledged indicator of a first type (S-NACK) indicating a root cause of stochastic nature, and/or
if the data was not successfully received due to a root cause of deterministic nature,
   then the device (101, 102) is configured to transmit to the second device (101, 102) a not-acknowledged indicator of a second type (D-NACK) indicating a root cause of deterministic nature.

37. The device (101, 102) according to embodiment 36,
wherein the device (101, 102) is configured to determine by which amount the root cause is of stochastic nature and by which amount the root cause is of deterministic nature, and
to transmit a weighted version of the not-acknowledged indicators (e.g. 60% D-NACK/40% S-NACK) to the second device (101, 102).

38. The device (102) according to any one of embodiments 1 to 37,
wherein the device (102) is configured to receive from and/or to transmit to a further device (101B) a second link-level report (105B) being related with a different second communication link (110B) between the device (102) and said further device (101B),
wherein said second link-level report (105B) comprises at least one of an information about
   a root cause of a change in link-level performance of the second communication link (110B),
   a measure to change link-level performance of the second communication link (110B), and
   a trend and/or an anticipated behavior of link-level performance of the second communication link (110B).

39. The device (102) according to embodiment 38,
wherein the device (102) is configured to relay or forward the link-level report (105), or at least a portion thereof, to said further device (101B), and/or
to relay or forward the second link-level report (105B), or at least a portion thereof, to the second device (101).

40. The device (102) according to embodiment 38 or 39, wherein
if the device (102) receives the link-level report (105) and the second link-level report (105B),
then the device (102) is configured to check whether the information about the measure to change link level performance as reported in the link-level report (105) and in the second link-level report (105B), respectively, are
   conflicting, and/or
   sufficiently coordinated to be non-conflicting, and/or
   suitable for remedying the root cause.

41. The device (102) according to embodiment 40, wherein
if the device (102) determines that the reported measures are conflicting and/or not sufficiently coordinated and/or not suitable,
then the device (102) is configured to
   intervene before said measures are applied, and/or
   coordinate the reported measures, and/or
   orchestrate the reported measures, and/or
   compensate the reported measures, and/or
   instruct and/or request the second device (101) or any other device (101B) to coordinate and/or orchestrate and/or compensate the reported measures.

42. The device (101, 102) according to any one of embodiments 1 to 41,
wherein the root cause for a change in link-level performance, the information of which is provided in the link-level report (105), is based on an inter-cell interference between the device (101, 102) residing in a first wireless communication cell (120) and at least one third device (201, 201B, 202) residing in a different second wireless communication cell (220).

43. The device (101, 102) according to any one of embodiments 1 to 42,
wherein the root cause of a change in link-level performance, the information of which is provided in the link-level report (105), is based on an inter-cell interference between the second device (101, 102) residing in a first wireless communication cell (120) and at least one third device (201, 201B, 202) residing in a different second wireless communication cell (220).

44. The device (101) according to embodiment 42 or 43,
wherein the device (101) is a user equipment being served by the first wireless communication cell (120) which is provided by the second device (102), and
wherein the at least one third device (202) is a base station providing the different second wireless communication cell (220).

45. The device (102) according to embodiment 42 or 43,
wherein the device (102) is a base station providing the first wireless communication cell (120) by which the second device (101) is served, and
wherein the at least one third device (201, 201B) is a user equipment being served by the different second wireless communication cell (220).

46. The device (101) according to embodiment 42 or 43,
wherein the device is a user equipment (101) being served by the first wireless communication cell (120) which is provided by the second device (102), and
wherein the at least one third device (201, 201B) is a user device being served by the different second wireless communication cell (220).

47. The device (102) according to embodiment 42 or 43,
wherein the device (102) is a base station providing the first wireless communication cell (120) by which the second device (101) is served, and
wherein the at least one third device (202) is a base station providing the different second wireless communication cell (220).

48. The device (101) according to any one of embodiments 1 to 47,
wherein the device (101) and the second device (102) are entities of a first wireless communication system (130),
wherein the root cause of a change in link-level performance, the information of which is provided in the link-level report (105), is based on an inter-system interference between the device (101) residing in the first wireless communication system (130) and at least one third device (201, 201B, 202) residing in a different second wireless communication system (230).

49. The device (102) according to any one of embodiments 1 to 48,
wherein the device (102) and the second device (101) are entities of a first wireless communication system (130),
wherein the root cause of a change in link-level performance, the information of which is provided in the link-level report (105), is based on an inter-system interference between the second device (102) residing in the first wireless communication system (130) and at least one third device (201, 201B, 202) residing in a different second wireless communication system (230).

50. The device (101) according to embodiment 48 or 49,
wherein the device (101) is a user equipment being served by a wireless communication cell within the first wireless communication system (130), the cell being provided by the second device (102), and
wherein the at least one third device (201, 201B) is a user equipment being served by a wireless communication cell within the different second wireless communication system (230).

51. The device (102) according to embodiment 48 or 49,
wherein the device (102) is a base station providing a wireless communication cell within the first wireless communication system (130), the cell serving the second device (101), and
wherein the at least one third device (202) is a base station providing a wireless communication cell within the different second wireless communication system (230).

52. The device (101) according to embodiment 48 or 49,
wherein the device (101) is a user equipment being served by a wireless communication cell within the first wireless communication system (130), the cell being provided by the second device (102), and
wherein the at least one third device (202) is a base station providing a wireless communication cell within the different second wireless communication system (230).

53. The device (102)according to embodiment 48 or 49,
wherein the device (102) is a base station providing a wireless communication cell within the first wireless communication system (130), the cell serving the second device (101), and
wherein the at least one third device (201, 201B) is a user equipment being served by a wireless communication cell within the different second wireless communication system (230).

54. The device (101) according to any one of embodiments 1 to 53,
wherein the device (101) and the second device (102) are entities of a first wireless communication system (130), and
wherein the device (101) and/or the second device (102) are configured to
   transmit a link-level report (105) obtained within the first wireless communication system (130) to at least one third device (201, 201B, 202) residing in a different second wireless communication system (230), and/or
   receive a link-level report (105x) from at least one third device (201, 201B, 202) residing in a different second wireless communication system (230).

55. The device (101, 102) according to any one of embodiments 48 to 54,
wherein the first wireless communication system (130) is of a first type of radio access network (RAN), and
wherein the second wireless communication system (230) is of a different second type of a radio access network (RAN).

56. The device (101, 102) according to any one of embodiments 48 to 54,
wherein the first wireless communication system (130) and the second wireless communication system (230) are of a same type of a radio access network (RAN).

57. A wireless communication system comprising a device (101, 102) and at least a second device (101, 102) according to any one of embodiments 1 to 56.

58. A method for operating a device (101, 102) in a wireless communication system (130), the method comprising steps of:
providing a communication link (110) to at least a second device (102),
transmitting and/or receiving a link-level report (105), and/or
controlling the communication link (110) by means of the link-level report (105) or being controlled based on information contained in the link-level report (105),
the link-level report (105) comprising at least one of an information about
   a root cause of a change in link-level performance of the communication link (110),
   a measure to change link-level performance of the communication link (110), and
   a trend and/or an anticipated behavior of link-level performance of the communication link (110).

59. A computer readable digital storage medium having stored thereon a computer program having a program code for performing, when running on a computer, a method according to embodiment 58.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

Abbreviations

| Abbreviati | Definition | Further description |
|---|---|---|
| 2G | second generation | |
| 3G | third generation | |
| 3GPP | third generation partnership | |
| 4G | fourth generation | |
| 5G | fifth generation | |
| 5GC | 5G core network | |
| ACLR | adjacent channel leakage | |
| | ratio | |
| AP | access point | |
| ARQ | automatic repeat request | |
| AU | antenna unit | |
| BER | bit-error rate | |
| BLER | block-error rate | |
| BS | basestation transceiver | |
| BT | Bluetooth | |
| BTS | basestation transceiver | |
| CA | carrier aggregation | |
| CBR | channel busy ratio | |
| CC | component carrier | |
| CCO | coverage and capacity | |
| CHO | conditional handover | |
| CLI | cross-link interference | |
| CLI-RSS | cross-link interference | |
| | received | |
| CP1 | control plane 1 | |
| CP2 | control plane 2 | |
| CSI-RS | channel state information | |
| CU | central/centralized unit | |
| D2D | device-to-device | |
| DAPS | dual active protocol stack | |
| DC-CA | dual-connectivity carrier | |
| DECT | digitally enhanced cordless | |
| DL | downlink | |
| DMRS | demodulation reference | |
| | signal | |
| DOA | direction of arrival | |
| DRB | data radio bearer | |
| DU | distributed unit | |
| ECGI | E-UTRAN cell global | |
| | identifier | |
| E-CID | enhanced cell ID | |
| eLLR | enhanced link-level report | Coined in this disclosure |
| eNB | evolved node b | |
| EN-DC | E-UTRAN-New Radio dual | |
| EUTRA | Enhanced UTRA | |
| E-UTRAN | Enhanced UTRA network | |
| gNB | next generation node-b | |
| GNSS | global navigation satellite | |
| GPS | global positioning system | |
| HARQ | hybrid ARQ | |
| IAB | integrated access and | |
| | backhaul | |
| ID | identity/identification | |
| IIOT | industrial Internet of things | |
| KPI | key-performance indicator | |
| LTE | Long-term evolution | |
| MCG | master cell group | |
| MCS | modulation coding scheme | |
| MDT | minimization of drive tests | |
| MIMO | multiple-input/multiple-output | |
| MLR | measure, log and report | |
| MLRD | MLR device | |
| MNO | mobile network operator | |
| MR-DC | multi-RAT dual connectivity | |
| NCGI | new radio cell global | |
| | identifier | |
| NG | next generation | |
| ng-eNB | next generation eNB | node providing E-UTRA |
| | | user plane and control |
| | | plane protocol terminations |
| | | towards the UE, and |
| | | connected via the NG |
| NG-RAN | either a gNB or an ng-eNB | |
| NR | new radio | |
| NR-U | NR unlicensed | NR operating in unlicensed |
| | | frequency spectrum |
| OAM | operation and maintenance | |
| OEM | OEM original equipment | |
| OTT | OTT over-the-top | |
| Open RAN | open radio access network | |
| PCI | physical cell identifier | Also known as PCID |
| PDCP | packet data convergence | |
| PER | packet error rate | |
| PHY | physical | |
| PLMN | public land mobile network | |
| QCL | quasi colocation | |
| RA | random access | |
| RACH | random access channel | |
| RAN | radio access network | |
| RAT | radio access technology | |
| RF | radio frequency | |
| RIM | radio access network | |
| RIM-RS | RIM reference signal | |
| RLC | radio link control | |
| RLF | radio link failure | |
| RLM | radio link monitoring | |
| RP | reception point | |
| R-PLMN | registered public land mobile | |
| RRC | radio resource control | |
| RS | reference signal | |
| RSRP | reference signal received | |
| | power | |
| RSRQ | reference signal received | |
| RSSI | received signal strength | |
| RSTD | reference signal time dif- | |
| | ference | |
| RTOA | relative time of arrival | |
| RTT | round trip time | |
| RU | radio unit | |
| SA | standalone | |
| SCG | secondary cell group | |
| SDU | service data unit | |
| SIB | system information block | |
| SINR | signal-to-interference-plus- | |
| SIR | signal-to-interference ratio | |
| SL | side link | |
| SNR | signal-to-noise ratio | |
| SON | self-organising network | |
| SOTA | state-of-the-art | |
| SRS | sounding reference signal | |
| SS | synchronization signal | |
| SSB | synchronization signal block | |
| SSID | service set identifier | |
| SS-PBCH | sounding signal/physical | |
| TAC | tracking area code | |
| TB | transmission block | |
| TDD | time division duplex | |
| TSG | technical specification group | |
| UE | user equipment | |
| UL | uplink | |
| URLLC | ultra-reliable low latency | |
| UTRAN | universal trunked radio | |
| | access | |
| V2X | vehicle-to-everything | |
| VoIP | voice over Internet protocol | |
| WI | work item | |
| WLAN | wireless local area network | |

1. A device for use in a wireless communication system,
the device comprising a communication link to at least a second device,
wherein the device is configured to transmit and/or receive a link-level report, and/or
wherein the device is configured to control the communication link by means of the link-level report or configured to be controlled based on information contained in the link-level report,
the link-level report comprising at least one of an information about
a root cause of a change in link-level performance of the communication link,
a measure to change link-level performance of the communication link, and
a trend and/or an anticipated behavior of link-level performance of the communication link.

2. The device according to claim 1,
wherein the communication link is a bi-directional communication link between the device and the second device.

3. The device according to claim 1,
wherein the communication link is a direct end-to-end link between the device and the second device, or
wherein the communication link is an indirect link between the device as one end and the second device as another end with a third device in between, wherein said third device is involved in a communication between the first and second devices via the communication link.

4. The device according to claim 3,
wherein the third device is involved in said communication by providing at least one path of the communication link via which a communication between the device and the second device takes place, and
wherein the third device is a configurable contributor to the communication link between the first and second devices.

5. The device according to claim 4,
wherein the third device is involved in said communication by relaying or forwarding signals between the first and second devices via the at least one path of the communication link that is provided by the third device.

6. The device according to claim 1,
wherein the device comprises a second link with the second device via which the link-level report is transmitted to or received from the second device,
wherein said second link is different from the communication link between the device and the second device.

7. The device according to claim 6,
wherein the second link, via which the link-level report is received or transmitted, is a unidirectional link between the device and the second device.

8. The device according to claim 1,
wherein the device is configured to acquire the link-level report by creating the link-level report by itself, and to transmit the created link-level report to the second device.

9. The device according to claim 8,
wherein the device is configured to include into the link-level report, as part of the information about the root cause of a change in link-level performance, at least one of an information
whether the root cause for the change in link-level performance is of stochastic nature or of deterministic nature,
whether the root cause for the change in link-level performance comprises a temporal dependency such that the link-level performance varies over time,
whether the root cause for the change in link-level performance comprises a spectral dependency such that the link-level performance varies with varying frequencies,
whether the root cause for the change in link-level performance comprises a spatial dependency such that the link-level performance varies with varying signal distribution in space,
whether the root cause for the change in link-level performance comprises a locational dependency such that the link-level performance varies at different locations of the device and/or of any further device being involved in a communication via the communication link,
whether the root cause for the change in link-level performance comprises an orientation-dependency such that the link-level performance varies with varying orientation of the device and/or of any further device being involved in a communication via the communication link,
whether the root cause for the change in link-level performance comprises a power-level-dependency such that the link-level performance varies with varying receive and/or transmission power levels of the device and/or of any further device being involved in a communication via the communication link,
whether the root cause for the change in link-level performance comprises a bandwidth dependency such that the link-level performance varies with varying occupied bandwidth,
whether the root cause for the change in link-level performance comprises a polarization dependency such that the link-level performance varies with varying polarizations of an antenna of the device and/or of any further device being involved in a communication via the communication link,
whether the root cause for the change in link-level performance follows a Gaussian distribution, and
an information about the mean and/or variance of a Gaussian distribution of the change in link-level performance.

10. The device according to claim 1,
wherein the device is configured to determine a root cause for the change in link-level performance as being of either stochastic nature or deterministic nature.

11. The device according to claim 10,
wherein the device is configured to consider variations over time and/or frequency of the changing link-level performance when determining the root cause.

12. The device according to claim 10, wherein
if the root cause for the change in link-level performance is determined as being of deterministic nature, then the device is configured to provide a counter measure for alleviating or compensating the change in link-level performance by applying at least one of the following measures:
varying one or more communication link parameters,
varying a scheduling of the communication link,
varying a beam coordination and/or a beamforming of an antenna of the device,
varying an alignment of a directive antenna of the device,
varying a spatial orientation of the device,
varying a position of the device,
switching to a different base station.

13. The device according to claim 10, wherein
if the root cause for the change in link-level performance is determined as being of stochastic nature, then the device is configured to provide a counter measure for alleviating or compensating the change in link-level performance by applying at least one of the following measures:
interleaving,
spreading,
randomized beam sweeping,
deterministic beam sweeping,
cyclic delay diversity,
hopping in at least one of time, frequency and space,
change of coding scheme,
space time codes, and
repetition coding.

14. The device according to claim 10, wherein
if the root cause for the change in link-level performance is determined as being of deterministic and stochastic nature, then the device is configured to provide a counter measure for alleviating or compensating the change in link-level performance by applying at least one of the following measures:
varying one or more communication link parameters,
varying a scheduling of the communication link,
varying a beam coordination and/or a beamforming of an antenna of the device,
varying an alignment of a directive antenna of the device,
varying a spatial orientation of the device,
varying a position of the device,
switching to a different base station
and to provide a further counter measure for alleviating or compensating the change in link-level performance by applying at least one of the following measures:
interleaving,
spreading,
randomized beam sweeping,
deterministic beam sweeping,
cyclic delay diversity,
hopping in at least one of time, frequency and space,
change of coding scheme,
space time codes, and
repetition coding.

15. The device according to claim 12,
wherein the device is configured to report to the second device the one or more counter measures that the device has applied in order to alleviate or compensate the change in link-level performance caused by a certain root cause,
wherein said report is sent via the link-level report as part of the information about the measure to change the link-level performance of the communication link.

16. The device according to claim 1,
wherein the device is configured to acquire the link-level report by receiving the link-level report from the second device.

17. The device according to claim 16,
wherein the device is configured to retrieve from the received link-level report, as part of the information about the root cause of a change in link-level performance of the communication link, at least one of an information:
whether the root cause for the change in link-level performance is of stochastic nature or of deterministic nature,
whether the root cause for the change in link-level performance comprises a temporal dependency such that the link-level performance varies over time,
whether the root cause for the change in link-level performance comprises a spectral dependency such that the link-level performance varies with varying frequencies,
whether the root cause for the change in link-level performance comprises a spatial dependency such that the link-level performance varies with varying signal distribution in space,
whether the root cause for the change in link-level performance comprises a locational dependency such that the link-level performance varies at different locations of the device and/or of any further device being involved in a communication via the communication link,
whether the root cause for the change in link-level performance comprises an orientation-dependency such that the link-level performance varies with varying orientation of the device and/or of any further device being involved in a communication via the communication link,
whether the root cause for the change in link-level performance comprises a power-level-dependency such that the link-level performance varies with varying receive and/or transmission power levels of the device and/or of any further device being involved in a communication via the communication link,
whether the root cause for the change in link-level performance comprises a bandwidth dependency such that the link-level performance varies with varying occupied bandwidth,
whether the root cause for the change in link-level performance comprises a polarization dependency such that the link-level performance varies with varying polarizations of an antenna of the device and/or of any further device being involved in a communication via the communication link,
whether the root cause for the change in link-level performance follows a Gaussian distribution, and
an information about the mean and/or variance of a Gaussian distribution of the change in link-level performance.

18. The device according to claim 16,
wherein the device is configured to determine, based on the information contained in the link-level report, a root cause for the change in link-level performance as being of stochastic nature or deterministic nature,
or to derive from the information contained in the received link-level report whether a root cause for the change in link-level performance is of stochastic nature or deterministic nature.

19. The device according to claim 18,
wherein the device is configured to consider variations over time and/or frequency of the changing link-level performance when determining the root cause.

20. The device according to claim 18, wherein
if the root cause for the change in link-level performance is determined as being of deterministic nature,
then the device is configured to provide a counter measure for alleviating or compensating the change in link-level performance by applying at least one of the following measures:
varying one or more communication link parameters,
varying a scheduling of the communication link,
varying a beam coordination and/or a beamforming of an antenna of the device,
varying an alignment of a directive antenna of the device,
varying a spatial orientation of the device,
varying a position of the device,
switching to a different base station.

21. The device according to claim 18, wherein
if the root cause for the change in link-level performance is determined as being of stochastic nature,
then the device is configured to provide a counter measure for alleviating or compensating the change in link-level performance by applying at least one of the following measures:
interleaving,
spreading,
randomized beam sweeping,
deterministic beam sweeping,
cyclic delay diversity,
hopping in at least one of time, frequency and space,
change of coding scheme,
space time codes, and
repetition coding.

22. The device according to claim 1,
wherein the device is configured to use an acknowledgement scheme for reporting to the second device whether data transferred via the communication link was successfully received by the device or not, wherein
if the data was not successfully received due to a root cause of stochastic nature,
then the device is configured to transmit to the second device a not-acknowledged indicator of a first type indicating a root cause of stochastic nature, and/or
if the data was not successfully received due to a root cause of deterministic nature,
then the device is configured to transmit to the second device a not-acknowledged indicator of a second type indicating a root cause of deterministic nature.

23. The device according to claim 22,
wherein the device is configured to determine by which amount the root cause is of stochastic nature and by which amount the root cause is of deterministic nature, and
to transmit a weighted version of the not-acknowledged indicators to the second device.

24. A method for operating a device in a wireless communication system, the method comprising:
providing a communication link to at least a second device,
transmitting and/or receiving a link-level report, and/or
controlling the communication link by means of the link-level report or being controlled based on information contained in the link-level report,
the link-level report comprising at least one of an information about
a root cause of a change in link-level performance of the communication link,
a measure to change link-level performance of the communication link, and
a trend and/or an anticipated behavior of link-level performance of the communication link.

25. A non-transitory digital storage medium having stored thereon a computer program for performing a method for operating a device in a wireless communication system, the method comprising:
providing a communication link to at least a second device,
transmitting and/or receiving a link-level report, and/or
controlling the communication link by means of the link-level report or being controlled based on information contained in the link-level report,
the link-level report comprising at least one of an information about
a root cause of a change in link-level performance of the communication link,
a measure to change link-level performance of the communication link, and
a trend and/or an anticipated behavior of link-level performance of the communication link,
when said computer program is run by a computer.
